(19) United States
(12) Patent Application Publication
(10) Pub. No.: US 2012/0311462 A1
(43) Pub. Date: Dec. 6, 2012

(54) SYSTEM AND METHOD FOR AN INTERACTIVE MOBILE-OPTIMIZED ICON-BASED PROFESSIONAL PROFILE DISPLAY AND ASSOCIATED SEARCH, MATCHING AND SOCIAL NETWORK

(76) Inventor: John Devecka, Pleasanton, CA (US)

(21) Appl. No.: 13/471,193

(22) Filed: May 14, 2012

Related U.S. Application Data
(60) Provisional application No. 61/485,443, filed on May 12, 2011.
(60) Provisional application No. 61/548,499, filed on Oct. 18, 2011.
(60) Provisional application No. 61/588,552, filed on Jan. 19, 2012.

(51) Int. Cl. G06F 3/01; G06F 15/16

(52) U.S. Cl. 715/753

(57) ABSTRACT

An icon-based interactive professional profile, search and matching system configured within professional network platforms and technologies enabling a user to generate a personalized interactive icon-based business or resume profile representing icon profile elements optimized for display and functionality on mobile devices. The icon profile system utilizes and integrates selected personalized icon profile elements and associated data for searching, compatibility matching, invitations, communities, and calendar functions. In professional network environments, icon elements are unitized to aggregate users based on a selected icon profile element and in further environments automatically compare and report compatibility between unknown users, which vastly improves professional network functionality.

### CROSS-REFERENCE TO RELATED APPLICATIONS

This application claims the benefit of U.S. Provisional Application No. 61/485,443, filed May 12, 2011, U.S. Provisional Application No. 61/548,499, filed Oct. 18, 2011, and U.S. Provisional Application No. 61/588,552, filed Jan. 19, 2012, each of which are hereby incorporated by reference herein in their entireties.

### FIELD OF THE INVENTION

Embodiments of the present disclosure relate to the field of professional social networking and employment networking. More specifically, the present invention relates to a mobile device-optimized interactive icon-based personal profile and resume with an associated search, matching and communication system for social professional network and employment-based communities.

### BACKGROUND OF THE INVENTION

Professional networking and business development applications have an important aspect of many people's daily professional and social life experience. Although conventional professional networking and employment-based applications are widely used, the functionality and usefulness of these applications are still very limited.

For example, conventional professional networking systems are limited in that business-related matches are identified and coordinated by the individual users based on some existing connection between the user and another individual with whom he or she wishes to connect. In addition, these systems allow users to create and display standard lengthy text based business resume information and professional profiles which are time consuming and monotonous to read and further lack any interactivity or direct network functionality. These highly limited business resume services and professional profile formats offered by conventional systems further limit the ability for a user to efficiently view and identify and contact compatible and appropriate connections within the professional networking environment. These issues are especially problematic and limiting when attempting to read or compare business resume information on a small mobile device screen.

Business development and professional networking computer-based applications also lack easy-to-read professional resumes and profiles configured to communicate relevant information to a viewer in an efficient manner. Conventional text-field based business profiles used in professional networking platforms typically lack depth, personality, consistency, uniformity, and readability since each user is free to write the descriptions in his or her profile in any way he or she chooses. In addition, text-field based profiles inherently possess language-based barriers for users who are not able to read and understand the language of another user's profile.

As such, current professional and employment social networking communication platforms do not offer a simple, efficient, and interactive profile display and system or method for establishing and searching a professional network. Current systems further lack the ability to identify multiple users based on a various methods of commonality between the professionals' interests, background, activities, and skill sets in various search, matching and social network environments.

Further social limitations exist in popular conventional online and mobile social network environments and technologies, especially text and video chat rooms, social forums and social gaming networks, few personal facts or commonalities about other users are known beyond the associated screen name and or profile picture, severely limiting the technology's potential social usefulness.

The severe limitations of resumes and professional profiles severely limits the capabilities of business searching, matching and social networking in all computer connected environments. In addition, conventional professional communication networks fail to generate new local profile match and search results for a user. Therefore an important need exists in the art for a new ubiquitous professional, services, and resume profiling method and system to vastly improve professional search, matching and social connectivity in professional networking environments and technologies, further configured to efficiently create, present, search, match, view, compare, share and display personal profile information among its users.

### BRIEF SUMMARY OF THE INVENTION

A system and method are presented for enabling a user to create a customizable interactive icon-based professional profile or resume representing the user's personal information, professional information, business skills, experiences, professional assessments, attributes, interests, places, likes, business personality, accomplishments, education, networking groups, recommendations, work history, and/or areas of specialty or expertise and utilize the icon-based professional profile to promote and connect with other potential clients, employers and professionals users in various professional social network environments. In an embodiment, via an icon profile creator tool, the format and content of an icon-based professional profile resume may be generated and customized based on one or more professional network genres selected by a user. Exemplary professional network genres may apply to all new and existing sites and communities for businesses & professionals including employment and resume sites, independent contracting services business networking sites and communities, professional events and associations sites and communities professional video and/or text chat networking and services, video broadcasting services, and social gaming networks, etc according to embodiments of the present invention, including but are not limited.

According to an embodiment of the present invention, the interactive icon-based profile technology and professional network system and method (also referred to herein as the “professional network icon system”) is configured to maintain multiple icons (e.g., a library or pallet of icons), each representing a professional profile element or elements. The professional network icon system is further configured to receive a selection of one or more icons from a user and generate a professional profile for the user based on the selected icon(s).

In one or more embodiments of the present invention, the business and professional network icon system provides additional customized and auto-generated compatibility results, user-to-user matching, or user-to-group matching based on icon compatibility, a location-based parameter or preference (e.g., an identified “zone” or geographic proximity relative to a selected location), and/or other matching criteria. As used herein, the term “zone” includes, without limitation, a defined geographic region, a user/professional, a place (e.g., a tradeshow location, an office location, etc.) or location (e.g., city, county, state) or a region defined by a certain radial distance from a given point (e.g., a 10 mile radius from point A). In an embodiment, a user's zone may represent a geographic region or radius based on the user's home, business, current location, or other specified location (e.g., a tradeshow location, a networking event, a planned destination such as a business travel location, hotel, or a new residence).

In an embodiment, the professional network icon system provides multiple users with a graphical user interface (or GUI) including a series of independently representative and functional profile icons and underlying profile elements from which to select in generating an icon-based professional profile or resume. An icon may include, but is not limited to, an image, a picture, a video, animation, or other visual indicator representing a professional profile element. As used herein, a professional profile element is intended to include any personal expression, such as a personality trait (e.g., business-related trait), interest, hobby, skill, preference, service, offer, achievement, certification, taste, award, attribute, statistic, certification, brand, education, experience, biographical data, goal, personal characteristic, business-related characteristic, etc. that may be selected by a user for inclusion in the user's professional profile. In an embodiment, a user may generate a professional profile including multiple icons relating to professional profile elements, such as, for example, the user's skills, birth town, prior work experience, educational background, work ethic, work style, achievements, certifications, specialized skill sets, etc.

According to embodiments of the present invention, multiple icons having one or more common attributes may be maintained and grouped into one or more icon categories. Exemplary icon categories include, but are not limited to, a business trait category, a work experience category, a community interest category, a professional experience category, an events category, a business services category, a recommendations category, an entertainment category, a lifestyle category, a work product category, an interests category, a profession category, an affiliation category, an education category, an associates category, a clients category, an athletics category, a hobbies category, etc. In generating a professional profile, the user may navigate the professional network icon system using the icon categories in order to identify the one or more icons to select for inclusion in his or her professional profile.

In an embodiment, the professional network icon system enables a user to customize each system or user-created icon. The icon creator system enables a user to associate one or more secondary descriptors with a selected icon(s) (i.e., an icon selected by a user for inclusion in the user's icon-based profile). A secondary descriptor may be any additional information linked or associated with an icon which is used to further define or describe a user's preferences, services, and relationship with the underlying professional profile element associated with the icon. According to embodiments of the present invention, the secondary descriptor may be a “secondary” icon associated with a primary icon (e.g., a primary icon representing an “attorney” professional profile element may have associated therewith a secondary icon representing a “commercial real estate attorney”), a text-based description, a rating, a service rate or offering, or any other expression which enriches, augments, or expands the accuracy of the relationship and preferences a user has with a user-selected icon. Unlike previous resume and business services profile technology, each icon and/or professional profile element is independently functional, useful and descriptive within the user's profile and the functionality of the entire professional networking system and environment.

In an embodiment, a user may identify one or more icons from his or her professional profile as a priority icon or visually differentiate in some manner from less important icons. The one or more priority icons selected by a user may be organized into a “billboard” or “highlighted” icon representing the most important professional profile elements associated with the user at that moment in time. These priorities may be efficiently viewed and changed, unlike standard text-based professional profiles constructed around associated sentences. For example, a user having a professional profile including fifty icons may select eight icons as priority icons (i.e., professional profile elements which are most representative or best define the user) and include those eight icons in the user's billboard. In an embodiment, a user's billboard may be the top-level display (e.g., initially displayed by the professional network icon system when encountering a user) associated with the user.

According to embodiments of the present invention, each of the multiple icons maintained by the professional network icon system may have a unique identifier (ID) and may be linked to search terms, tags, keywords, associations, selected secondary descriptors, and/or user tags for use in matching users of the professional network icon system according to various system and user-selectable matching methodologies. Furthermore, the system may match a user's icon profile elements against the database of other users with similar or matching profile elements and provide associative recommendations to the user consisting of icon element based professional activities, social activities, education, groups, and other factors may have a positive impact to the user's career.

Advantageously, the independently functional and informative icons create an interactive icon-based professional profile. The professional profile creation and publishing method of the present invention achieves a socially and professionally acceptable, concise, consistent, and vast graphical presentation of a professional, especially on touch based mobile devices with small displays. Accordingly, embodiments of the present invention overcome time and professional constraints and barriers associated with conventional virtual and real-life professional networking. The professional network icon system allows users to efficiently identify, form and maintain a connection via online professional communities based on the user's own professional profile elements and the professional network icon system. As a result, the professional network icon system enables new in-person business development and/or employment opportunities and capabilities among otherwise unknown and un-connected users and/or un-filled employment opportunities having highly compatible profiles (e.g., compatible professional experience, professional interests, professional schedules, skill sets, proximity, etc.). In addition, the icon-based professional profile may be introduced into existing social and professional network genres and technologies to virtually connect and introduce users to other compatible users, clients, consumers, and businesses in those environments.

According to embodiments of the present invention, a user's icon-based professional profile may be integrated and/or transported for use in other system-defined or third party environments. For example, a professional profile may be employed (e.g., used to represent a user) in one or more of: an environment focused on identifying new employment opportunities, networking, or business relationships; an icon-specific community (e.g., an “attorney” community including other users sharing a common interest in the legal professional); a clique or group of users matched based on a similarity of their respective professional profiles; establishing a business calendar; and/or an external web service, professional network, or environment (collectively referred to as an “external environment”). Exemplary external environments in which the icon-based professional profile may be used to represent a user include, but are not limited to, a video and/or media broadcasting community, an event-based network, a travel and/or leisure web service, a social gaming network, a video and/or text chat platform, an employment network, a business networking network, an independent contractor network, an industry events and association network, a business groups network, a retail and/or user marketplace, or an existing professional network (e.g., LinkedIn®). In this regard, the icon-based professional profile is a transportable professional profile that may be used to represent a user in any number of other virtual contexts and environments.

In embodiments of the present invention, the professional network icon system may be configured to allow businesses, individuals and advertisers to promote goods and/or services to users, groups or icon communities. In an embodiment, advertisements and/or promotions may be directed to users of the professional network icon system based on a user's data, such as his or her professional profile, professional profile elements, user site and activity usage history, brand preferences, test and survey data, acceptance of advertisements and services, specific professional profile elements, geography, secondary icon preferences, business cliques, events, groups, etc. Advantageously, advertising efficacy and mutual user and advertiser benefits are realized by the professional network icon system since a user's icon profile represents user-specified, highly specific personal data regarding the user's professional profile elements (e.g., interests, activities, preferences, etc.). In addition, business profile account holders may promote their services to clients, representatives of corporations and others.

According to embodiments of the present invention, the professional network icon system may be configured to generate an icon based resume, consisting of individually interactive and communicable professional icon elements, based on a user's professional profile. Advantageously, icon-based resumes are quick and easy to read and comprehend and view. Additional secondary detail and function is only displayed when a user selects one of the professional icon elements. Furthermore, icon-based resumes graphically provide information about a potential business associate or employment candidate. In addition, interactive icon-based resumes allow a reader to inquire and learn additional information about particular traits or skills represented by an icon on the icon-based resume. In an embodiment, certain certifications, surveys, tests and qualifications may be validated by the professional network icon system or other users to ensure accuracy, credibility and trustworthiness regarding the information presented in the icon-based resume.

In an embodiment, the format of the icon-based resume may be configured and/or customized by the user. In this regard, the manner in which a user selects the format of a resume and the icons for inclusion on the resume produce a basis for review and evaluation of the candidate's skills relating to an employment or business opportunity. In an embodiment, viewers may also publicly or privately rate a user's business profile or resume. This data may be used in many ways including effecting placement in search results. In another embodiment, only the user who created the professional profile may view the profile feedback provided by the community. In an embodiment, a user's professional profile and status may be easily updated and altered based on scheduled events, meetings, achievements, and geographic data.

In additional embodiments, computing devices for performing the operations of the above described embodiments are also implemented. Additionally, in embodiments of the invention, a computer-readable storage media stores methods for performing the operations of the embodiments described in the present application.

### BRIEF DESCRIPTION OF THE DRAWINGS

The present disclosure will be understood more fully from the detailed description given below and from the accompanying drawings of various embodiments of the disclosure.

FIG. 1 illustrates an exemplary arrangement of associated icons maintained by the professional network icon system, according to embodiments of the present invention;

FIG. 1A illustrates an exemplary arrangement of a primary icon and associated secondary icons, according to embodiments of the present invention;

FIG. 2 is a diagrammatic representation of a workflow illustrating an exemplary genre-based professional profile creation process, according to embodiments of the present invention;

FIG. 3 illustrates exemplary interface of an icon-based professional network system displaying an icon-based professional profile or resume associated with a first user including exemplary secondary descriptors, according to embodiments of the present invention;

FIG. 4 illustrates an exemplary interface of a mobile device application of an icon-based professional network system, according to embodiments of the present invention;

FIG. 5 illustrates an exemplary process flow for generating an icon-based professional profile, according to embodiments of the present invention;

FIG. 6 illustrates an exemplary interface of an icon-based professional network system displaying a professional profile creation tool, according to embodiments of the present invention;

FIG. 7 illustrates an exemplary process flow for generating a customized icon-based professional profile including secondary preferences according to embodiments of the present invention;

FIG. 8 illustrates an exemplary interface of an icon-based professional network system displaying secondary descriptors associated with an icon, according to embodiments of the present invention;

FIG. 9 illustrates an exemplary interface of an icon-based professional network system displaying an exemplary user-generated icon process, according to embodiments of the present invention;

FIG. 10 illustrates an exemplary interface of an icon-based professional network system displaying an exemplary “smart clique” user group creator tool, according to embodiments of the present invention;

FIG. 11 illustrates an exemplary process flow for searching within an icon-based professional network system, according to embodiments of the present invention;

FIG. 12 illustrates an exemplary interface of an icon-based professional network system displaying exemplary search results returned by the icon-based professional network system in response to a user search, according to embodiments of the present invention;

FIG. 13 illustrates an exemplary interface of an icon-based professional network system displaying an exemplary icon-based community or clique, according to embodiments of the present invention;

FIG. 14 illustrates an exemplary interface of an icon-based professional network system displaying exemplary search results returned by the icon-based professional network system in response to a search including secondary descriptor criteria, according to embodiments of the present invention;

FIG. 15 illustrates an exemplary interface of an icon-based professional network system displaying an exemplary icon-based business calendar, according to embodiments of the present invention;

FIG. 16 illustrates an exemplary interface of an icon-based professional network system displaying an exemplary invitation and chat associated with an event, according to embodiments of the present invention;

FIG. 17 illustrates an exemplary process flow for using a generated icon-based professional profile in multiple professional network environments, according to embodiments of the present invention;

FIG. 18 illustrates an exemplary interface of an icon-based professional network system displaying an exemplary icon-based community, according to embodiments of the present invention;

FIG. 19 illustrates an exemplary interface of an icon-based professional network system displaying an exemplary icon-based video chat, according to embodiments of the present invention;

FIG. 20 illustrates an exemplary interface of an icon-based professional network system displaying an exemplary gaming environment, according to embodiments of the present invention;

FIG. 21 illustrates an exemplary process flow for creating and/or delivering a concierge service or advertisement in the icon-based professional network system, according to embodiments of the present invention;

FIG. 22 illustrates an exemplary interface of an icon-based professional network system displaying an exemplary advertisement creation and delivery tool, according to embodiments of the present invention;

FIG. 23 illustrates an exemplary interface of an icon-based professional network system displaying an exemplary advertising delivery tool, according to embodiments of the present invention; and

FIG. 24 illustrates is a block diagram of an exemplary computer system that may perform one or more of the operations described herein.

### DETAILED DESCRIPTION

An interactive icon-based professional profile and associated professional networking system (or “professional network icon system”) configured to provide a graphical interface including information comprising multiple independently actionable icons further independently layered with user personalization and functionality within the icon user search and professional network community environment. The professional network icon system provides an efficient, effective, and enjoyable professional network platform for multiple users wishing to find, meet, and share with other users based one or more areas of compatibility. The professional network icon system may be configured in various ways, including, for example, as a stand-alone web site or application with multiple professional community genre categories including a mobile application or within existing professional network programs, blogs, video chats, social gaming communities, other sites, or communities to quickly and efficiently promote personal and business related attribute commonalities and awareness between unknown users, increase peer to peer communication and identification, and provide related features and functionality of the professional network understanding. The professional network icon system uses icons to enhance profile reading efficiency, user communication and network growth, such as via an API interface or by direct integration of a customized icon profile software module.

A user may create or have a professional profile created for them including multiple icons (i.e., an icon-based professional profile). Each icon represents a professional profile element and may be actionable to permit connection, peer communication, formation of communities, invitations, and dialog associated with the professional profile element underlying the icon.

According to embodiments of the present invention, the professional network icon system includes one or more computing devices configured to perform the steps, functions, actions, features, processes, communications, activities, etc. described throughout the present application. In embodiments of the present invention, the one or more computing devices configured to implement the professional network icon system may operate within a single computing device (e.g., a server) or on multiple computing devices.

The professional network icon system may comprise any number of computer components (e.g., computer-implemented instructions, programs, scripts, etc.) implemented together in a single device or networked in various combinations of multiple different devices that operate together. Examples of a computing device that may be configured to implement the icon-based professional network include, but are not limited to, a server, a mainframe computer, a networked computer, a process-based device, and similar type of systems and devices. The network may include the Internet in one embodiment. In other embodiments, other networks, wired and wireless, such as an intranet, local area network (LAN), wide area network (WAN), or broadcast network may be used.

The professional network icon system and its associated computing platform are configured to communicate with multiple users operating a suitable user device via a suitable network. The user device may be any type of computing device, for example, any data processing device, such as a desktop computer, a laptop computer, a mainframe computer, a personal digital assistant, a server, a handheld device, or any other device able to process data configured to execute one or more software programs configured to perform one or more functions, a device including a processing device (e.g., a processor), a computer-readable medium, and a memory. In some embodiments, the user device may be executing a browser application or other application adapted to communicate over Internet related protocols (e.g., TCP/IP and HTTP) and/or display a user interface.

In an embodiment, the professional network icon system may include a client operating on the user devices which is configured to communicate with a server to perform the functionality described in detail in connection with the Figures of the present application. For example, the icon-based professional network system may be implemented by having a client application on a mobile device associated with the user, wherein the client application is configured to communicate with one or more remote computers (e.g., one or more servers) via a network.

In an embodiment, the professional network icon system includes and/or is associated with a database (herein the “icon database”) configured to store the multiple icon profiles and instructions associated with the processes performed by the professional network icon system. The icon database may include any computer readable storage medium. The term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media. Other alternate mobile efficient technology may be integrated and utilized in conjunction with the described invention to multitask, improve site navigation, purchases and search commands and the like, which may be voice activated and controlled by mobile applications.

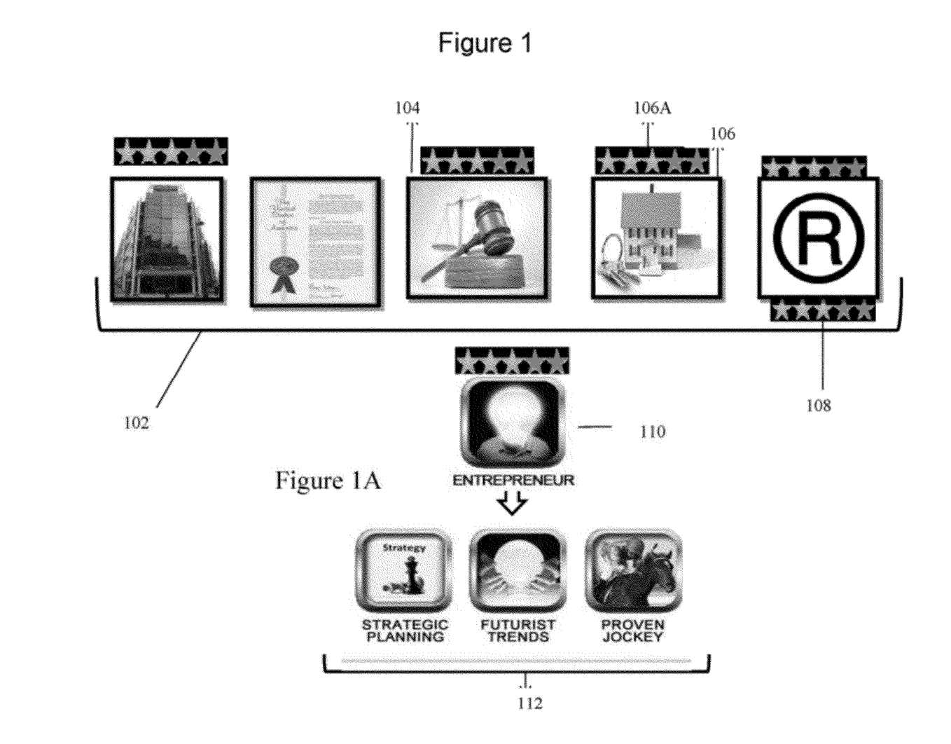

FIG. 1 illustrates an exemplary selection of icons maintained by the professional network icon system, according to embodiments of the present invention. In FIG. 1, an icon bank 102, or a collection of category-related icons is shown. The exemplary icons in the icon bank 102 provide examples of the vast communication properties of the professional network system-selected icon images within a category for use with the professional network icon system. As shown, the exemplary icons provide and communicate important and instant compatibility information relative to a type of professional profile element (e.g., a particular activity or interest), without the presentation of text header descriptors. Construction by the professional network icon system or use of the available icons may contain visual properties to distinguish subgroup or sect preferences and differences which may be linked to the category and sect search terms.

The example icon bank 102 includes five icon images relating to the legal profession. Each icon represents a different subcategory or sect having an established and instantly familiar meaning to those having an interest in the category associated with the icon bank 102 (in this case, the legal profession). For example, use of a generic or nondescript or less specific professional icon may provide a less accurate or incorrect assessment of compatibility and may cause a negative result for a professional connection, chat, service offering, employment, or associated joint activity. However, selecting a broader, more generic category icon may be utilized to increase the number of match results and potential contacts.

For example, a first user selecting icon 104 for inclusion in his/her professional profile and a second user selecting icon 106 for inclusion in his/her professional profile have both indicated an association with the legal profession, however, they are not necessarily compatible with a common legal association or common candidates for a legal employment opportunity. In this example, the first user selecting icon 104 is a general litigator while the second user selecting icon 106 is a real estate transactional lawyer. Matching sects accurately may be important to compatibility or to finding precise skills and services in some cases.

As shown in FIG. 1, via an icon preference and personalization creator tool, a user is able to indicate a skill or experience level associated with the icon, such as, for example, using the skill level indicator banner 106A. The skill level associated with an icon represents a secondary descriptor which may be used by the professional network icon system and the user in determining compatibility among users or matching with potential job opportunities, professional associations, etc. For example, a first user indicating a skill level 106A associated with icon 106 may not be compatible with a second user indicating a higher skill level associated with the same icon 106 or an employment posting requiring a minimum skill level rating of four starts or greater, which may be presented in an associated “key” as 8-10 years work experience, even if the second user and job posting related to residential real estate transactions.

In another example, a first user selecting a general litigation icon 104 and a second user selecting a residential real estate transactional lawyer icon 108 may not practice in the same area of the law. However, the first user selecting icon 104 may wish to connect with the second user selecting icon 106 for other purposes, such as, for example, if the first user is considering a change in discipline, if the first user is in need of a real estate attorney reference, or if the first user is holding an attorney-only charity softball event. In this regard, the professional network icon system enables users to make their own assessments of an acceptable match based on a consideration of the icons and secondary data included in another user's icon profile.

As shown in FIG. 1, another secondary descriptor that may be associated with a professional icon is a passion level indicator 108. A user may indicate his or her passion level associated with a professional profile element represented by an icon using, for example, the passion level indicator banner 108 shown in FIG. 1. The passion level may be used as a secondary descriptor and a further basis for identifying and determining matches among users and professional networking opportunities of the professional network icon system. These secondary system descriptor selection options may be standardized or customized by the system for different icon profile element types such as providing a different secondary structure option for an education icon compared to a business service icon type

FIG. 1A illustrates an exemplary icon 110 representing a general characteristic or trait of the underlying professional profile element (e.g., a general entrepreneur icon). A user may select icon 110, or select a pop up text based secondary descriptor to indicate that the user is a general entrepreneur seeking any new investment opportunities, in order to generate more matches and attract more invitations and professional opportunities. In an embodiment, a generic icon, such as icon 110, may also be associated with a subcategory 112 of icons which further define particular professional profile elements related to the top level generic category icon 110 that a user may include in his or her professional profile. In embodiments, creating a subcategory 112 may clarify, define or refine a user's preferences, traits, or capabilities, such as, for example, indicating a that the user is a strategic planner, knowledgeable regarding futurist trends, participates in particular hobby or activity (e.g., the user is a proven jockey), favorite motorcycle brand, link to other related media (e.g., videos, images), or providing a link to the user's blog, past and future activity, calendar and posting history relating to the professional profile element. In an embodiment, some or all of the secondary descriptor information and data may be used as one or more tags or keywords in the professional network icon system, in particular, in search and matching algorithms, described below in greater detail.

In embodiments of the present invention, a secondary descriptor indicator may be associated with an icon (e.g., 110) to indicate further information regarding a user's relationship with an icon and its underlying professional profile element. For example, icon 110 may have associated therewith an indicator (not shown) such as a “G” for general interest, “I” inactive, “M” for mentor, “R” for retired, “D” for holding a degree with respect to a discipline, or other like secondary descriptors. Secondary descriptors allow accurate refinement, consistent representation and statistical data of an otherwise generic user icon profile element which is another aspect of the icon system. In some cases, secondary descriptors may be prominently displayed on the main profile page view with the icon profile element.

As shown in FIGS. 1 and 1A, the professional network icon system is configured to provide richly detailed and/or layered animated icon-like images with revealing secondary descriptors and secondary or subcategory icons and associated information relating to a professional profile element (e.g., a profession, business-related trait, or other category) which communicates further details relating to the user's preferences and attributes. This body of information may be used by the professional network icon system to enable a user to more accurately and precisely select or identify other users and their preferred matches quickly, without reading and searching a user's text profile in which much of this information is typically absent. In embodiments, the icons and associated secondary descriptors may be considered in generating and enhancing the accuracy of search results, matches, advertising, groupings, and online forums.

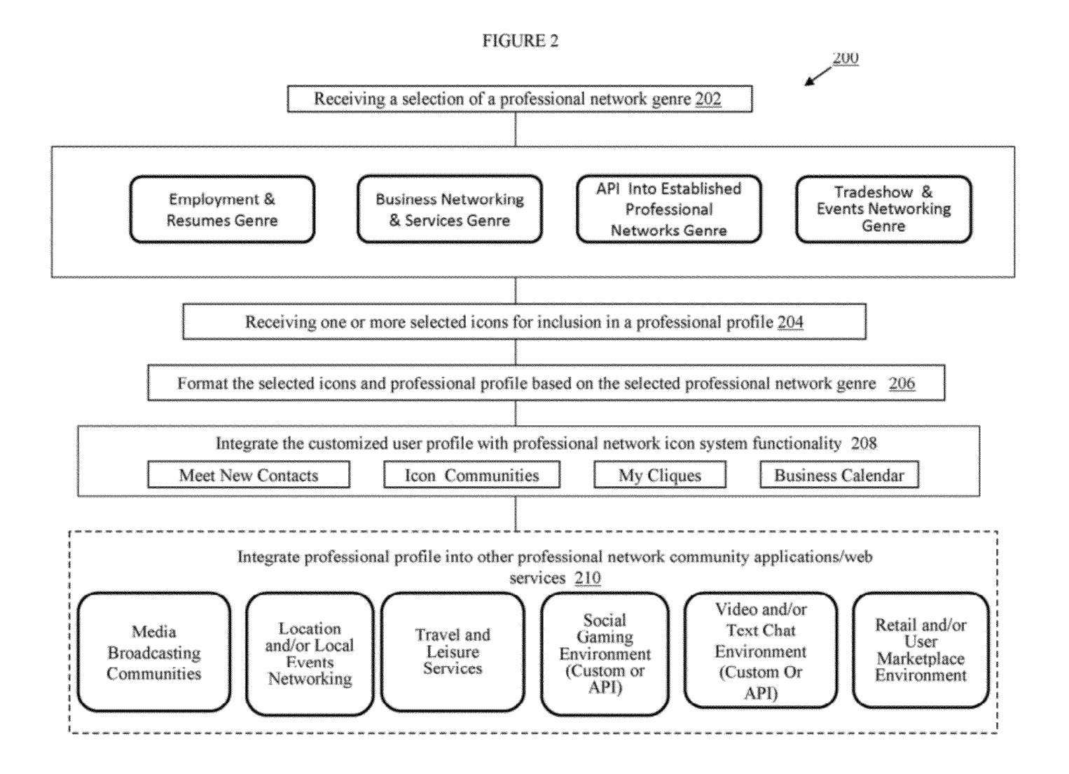

FIG. 2 illustrates a workflow illustrating an exemplary genre-based professional profile creation method 200, according to embodiments of the present invention. As shown in FIG. 2, in method 200, a user may interact with the professional network icon system in order to create a professional profile using a professional network genre provided by the professional network icon system. In block 202, a selection of a professional network genre is received by the professional network icon system. A professional network genre may be any community demographic target, unique technology service, area or use associated with professional networking which may be used as a guide for the user in establishing a professional profile within the professional network icon system. In embodiments, the professional network genre type may provide a framework and target community or social network technology within which the user may create a professional profile, and have any number of setup screens or steps that are associated with, related to, or customized for a particular genre type. Exemplary professional genre types may include, but are not limited to, an employment and resume genre, a business networking and services genre, an application programming interface (API) into an established professional networks genre, and/or tradeshow and events networking genre, a resume and employment service, a business event service, a professional social network, an independent contractor network, a gaming social network, an established and/or new vanity page social network genre, and an established and/or new media services (e.g., video chat, text chat, video broadcast services). One having ordinary skill in the art will appreciate that in addition to the examples described herein and shown in FIG. 2, other genre types may be employed in connection with embodiments of the present invention. Advantageously, the professional network icon profile system enables a user to user his or her professional icon profile as a way to be identified in various other social and professional environments.

In embodiments of the present invention, based on the selection of the professional network genre received from a user in block 202, an appropriate portal (e.g., an API or a set-up wizard) may be employed which guides the user through one or more steps relating to the creation of a professional profile or the professional network icon system may offer fully integrated professional network genre systems and portals. In an embodiment, the professional profile setup steps may be genre-specific such that the particular genre selected by the user informs the professional profile setup workflow (e.g., the types of information and manner of presentation of screens, fields, prompts, icons, etc. presented to the user during the professional profile creation process).

In block 204, the professional network icon system receives one or more selected icons for inclusion in the professional profile. In an embodiment, the icons may be selected by a user from a genre-specific pallet or library of icons. In block 206, the professional network icon system formats the selected icons and the professional profile based on user preferences and the selected professional network genre and associated technology environments available. In an embodiment, based on the selected genre, particular formatting and/or customizing may be performed with respect to the icons and/or professional profile. For example, if a user selects the employment and resumes genre, the associated professional profile may be formatted in view of the user's mobile device limitations (e.g., bandwidth capabilities, display size) and include information relating to the user's prior employment, current employment status, desired work location, etc. In an embodiment, in block 206, the professional network icon system may receive secondary descriptor information from the user to customize the selected icons included in the professional profile.

In block 208, the professional network icon system integrates the customized professional profile with one or more functional areas of the professional network icon system (i.e., the professional network icon system functionality) for use of the professional profile within the various functional areas. Exemplary professional network icon system functions and professional networking categories, shown in FIG. 2, include, but are not limited to, “meet new contacts” functionality, “icon communities” functionality, “my cliques” functionality, and/or “business calendar” functionality. It is noted that various additional areas of functionality are included within these categories, and that the examples shown in FIG. 2 are for illustration purposes.

Optionally, in block 210, the professional network icon system may integrate the customized professional profile with other environments including controlled and external professional network community applications and/or web services. The optional nature of block 210 is represented in FIG. 2 by a dashed line. The other professional network community applications, technologies, and/or web services may include professional network icon system-based and/or third party environments, applications, programs, and/or web services, such as, for example, third party travel websites/applications, third party professional networking websites/applications, third party retail websites/applications, etc. Exemplary functional areas of the professional network icon system, shown in FIG. 2, include, but are not limited to, resume and employment sites, professional networking sites, professional services sites, media broadcasting communities, location and/or local events networking, travel and leisure services, social gaming (e.g., custom or API-based), video and/or text chat environments (e.g., custom or API-based), and/or retail and/or user-based marketplace environments. The professional network icon system may be applicable for integration into a variety of online professional and social environments and technologies.

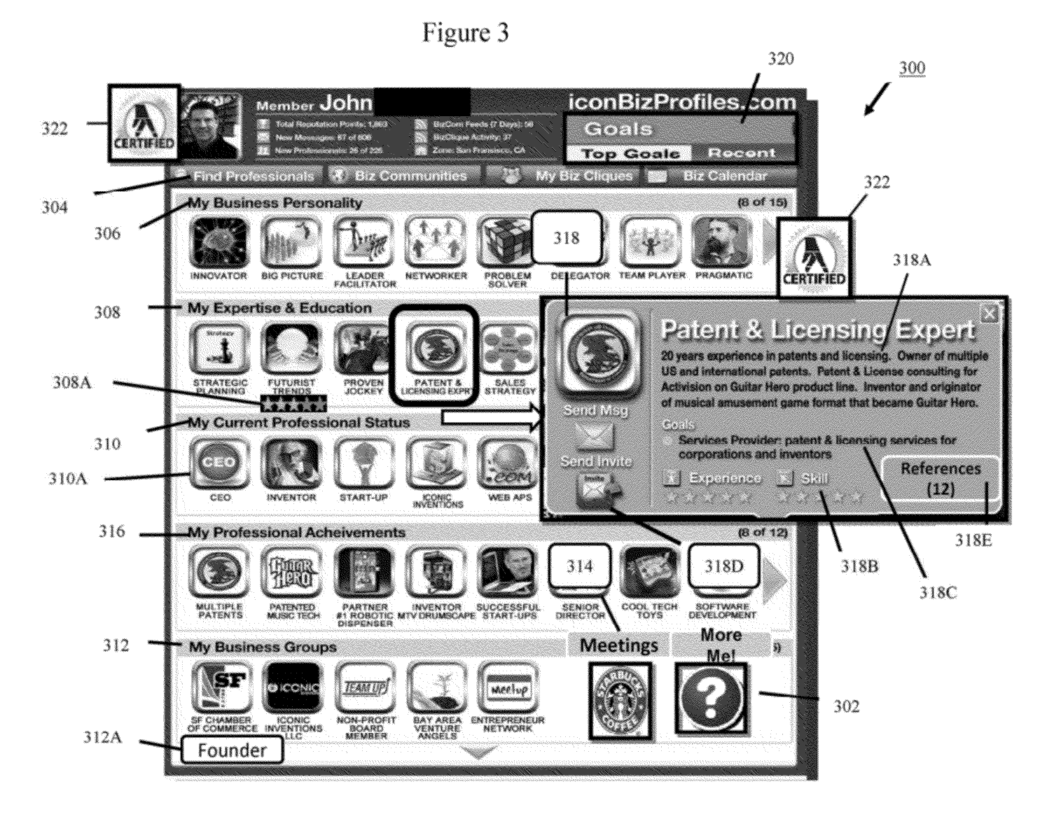

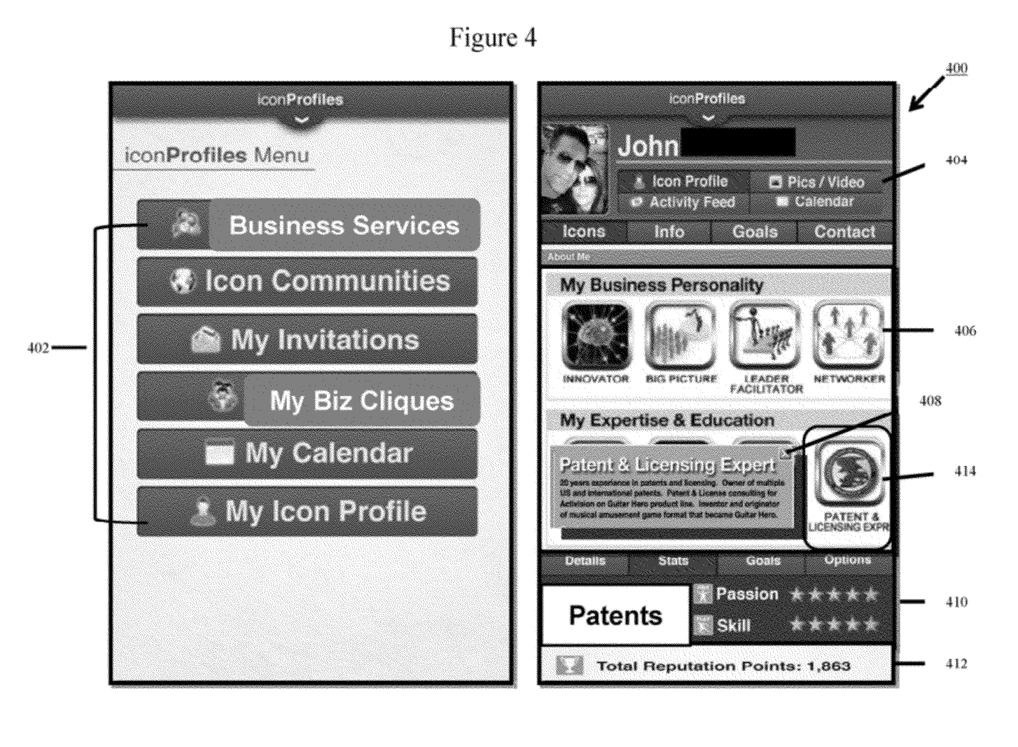

FIG. 3 illustrates exemplary interface of an icon-based professional network system displaying an icon-based professional profile 300 associated with a first user (i.e., “John”) including exemplary secondary descriptors shown in a pop up or revealing display, according to embodiments of the present invention. The exemplary professional profile 300 may be formatted to operate and be displayed via the professional network icon system on a mobile phone (as shown in FIG. 4), a mobile tablet or other computing device, according embodiments of the present invention. Each icon of the professional profile 300 may be interacted with (e.g., touched in a touch-screen environment or interacted with a pointer device such as a mouse) or with voice activation in order to perform an action associated with the selected icon (e.g., obtain additional information about an icon).

As shown in FIG. 3, the professional profile 300 may include an image (e.g., an actual picture or avatar) identifying the user associated with the professional profile 300. It is to be appreciated that for privacy reasons, a user may elect to use an avatar or partially revealed profile display instead of an actual photograph. In an embodiment, the user may create an avatar that resembles the user for their public professional profile. This privacy feature is useful for currently employed users or when rejecting offers for business opportunities, friendship and encourages more users join and set up profiles.

In yet another embodiment, the professional network icon system may be configured to only use avatar or no profile pictures in a public version of a professional profile (i.e., a version of the professional profile that is accessible by any user of the professional network icon system). In an embodiment, a private professional profile (i.e., a professional profile accessible only by other user who are connected or linked to the user) may include a user's actual profile picture and may be revealed with authorization after a connection is accepted or if a person is linked to a user's friend. This allows all users to experience match results with other professional profiles maintained in the icon database, but only reveal his or her identify (e.g., real name, contact information and/or picture) to other users that he or she accepts or connects with. In an embodiment, a user may request participation of another person in the professional network icon system by sending email invitations derived from their email contacts or friend lists and related data available from other sites or email accounts. In an embodiment, a user's imported friends, clients, business associates, and colleagues which are identified as such, may be automatically categorized in contact or icon activity groups (e.g., one or more “Biz Communities” or “My Biz Cliques” shown in FIG. 3) and icon compatibility may be determined and reported. In an embodiment, imported contacts may be automatically highlighted and linked to a priority status position in the user's features, social communities, search results and/or other suites in the professional network icon system, as described below. In some cases, users may discover new interests of their business associates and realize an ‘actual’ compatibility ranking with those associates using the professional network icon system. Active users or other selected mutually compatible users may also receive priority, mutual public community identification, virtual introduction encouragements, community recognition, status and perks compared to less active users of the icon system and low compatibility users.

In an embodiment, a user may also determine compatibility and shared traits and participate in communities with a larger group, location, or different community or alternately selected zone based on elements in their professional profile. These compatibility trends may be posted to the members of a given community (e.g., a geographic community, an event, or an icon-based community). Under certain settings, when a user has accepted another user for an activity, users may share typical narrative personality profiles or schedule a mutual video chat provided by the icon system, whereby the other user is able to learn more about their new potential business associate or group prior to or instead of an initial meeting. In an embodiment, a privacy setting may be controlled by the user with respect to any data and/or icons in the user's profile to enable the user to control which information/icons are displayed publicly (i.e., as part of the user's public profile).

In an embodiment, some information and preferences may be utilized by the icon system to determine compatibility without explicitly stating or presenting every realized compatibility element. Some personal information, survey and test result icons, other selected icons and data may be viewed by the user but still used by the system and maintained in an inactive or private icon page or folder. Some icon elements may not have associated social communities or secondary characteristics. This data may be displayed and used in the icon system based on the user's preference requirements. In an embodiment, a narrative may be composed automatically for the user based on icon data or partially derived from a personality profile test administered by the system or selected by the user, by usage, or icon profile data, and may be accessed via an icon such as the “More Me” icon 302.

For example, a text description generated by the professional network icon system associated with a user named Rich may include “Rich is married, in the legal field, with 2 boys, Johnny and Jake under 8 years. Rich likes all outdoor activities and is very competitive and athletic. He is a straight shooter and will do anything to complete a project on schedule. Rich's 5 favorite activities are: attending continuing education seminars, training junior associates, playing basketball, playing guitar, and running. He is typically free on Tuesday evenings after 7 PM PST. Check out his business calendar openings and join or invite him to your next networking event.” Other “More Me” icon 302 content may include any other profile categories, associations, elements and associated secondary elements that are deemed less important or superfluous by the user.

As shown in FIG. 3, the professional profile 300 is integrated with various features, functionality and environments 304 (e.g. a “Find Professionals” environment, and “Biz Communities” environment, a “My Biz Cliques” environment, and a “Biz Calendar” environment). A user may access these environments 304 from his or her professional profile, and use his or her professional profile elements and functions in those respective environments 304.

In an example, the “Find Professionals” environment may include various professional and services searching and matching features. In another example, the “Biz Communities” environment may include all the available internal and external API social network and employment environments technologies and genres. In a further example, the “My Biz Cliques” environment may include other user and services categorization methods, user commonality determination method options and a communication system for categorizations for matched search results. Social Calendar includes an icon based social calendar which is fully integrated with icon profile elements, an invitation system, notifications, and an events management system.

As shown in FIG. 3, the professional profile 300 may include multiple icon categories or groups, offered by the icon system or customized by the user targeted for a professional network genre, for example, the “My Business Personality” icon category 306, the “My Expertise & Education” icon category 308, the “My Current Professional Status” icon category 310, the “My Professional Achievements” category 316, the “My Business Groups” icon category 312, and the “Meetings” icon category 314. It is noted that the professional profile may include any number or type of icon categories, profile display and format options, profile pages, and sub pages and each icon category may include any number of icons as desired by the user creating the professional profile.

In an embodiment, the “My Business Personality” icon category 306 may include icons representing a range of business-related traits and/or characteristics potentially not related to a particular interest and/or activity, such as, for example, an “innovator” trait, a “big picture” trait, a “leader/facilitator” trait, etc. The most important icon elements of any category may be presented in importance ranked order or they may simply be highlighted as such or display a secondary descriptor for any profile category. Some or all public profile icons may have user-selected information or functionality that is restricted for privacy purposes, which includes blocking secondary information from being revealed, even if the icon system utilized that information for determining compatibility.

As shown in FIG. 3, the professional profile 300 may also include an exemplary icon section or grouping captioned “My Expertise & Education” 308 relating to the user's activities, skills, traits, characteristics, educational background, strengths, and the like.

The professional profile 300 may also include an exemplary icon section or grouping relating to the user's current professional status, affiliations, employer(s), title(s), positions, etc. (e.g., the “My Current Professional Status” section 310). In an embodiment, the professional profile 300 may include an exemplary icon section or grouping (e.g., the “My Professional Achievements” group 316 shown in FIG. 3) including icons associated with the user's professional, educational and/or business-related achievements, certifications, titles, positions, work experience, etc.

In an embodiment, the professional profile 300 may include an exemplary icon section or grouping (e.g., the “My Business Groups” section 312) including icons associated with one or more business groups with which the user has created, founded or is a member. In an embodiment, the professional profile 300 may include an exemplary icon section or grouping (e.g., the “Meetings” section 314) including one or more icons associated with one or more locations where the user typically likes to conduct business-related meetings. In an embodiment, the “Meetings” icon category 314 may be linked to a map and/or business calendar in order to quickly arrange a meeting or a group activity. While at these locations, users of the system may “check in” and meet, search or be matched to other system users who are present at that same time.

In an embodiment, a user may store and prioritize location icons for frequent activity meeting places. The structure and look of icon profiles, categories and icons may be customized by the user. An array of indicators may be displayed in association with each icon in a profile to inform the searcher of the user's preferences, status, events, activity and the like to enhance the efficiency of the icon system. In another embodiment, an integrated, pictorial collage-like image profile is used as a profile page.

In an embodiment, a “My Store” icon category (not shown) may be provided in the professional profile and provide a portal to an environment wherein the user may offer to sell, buy, recycle or promote personal items and services (potentially for a fee) which may be viewed on the professional profile page or in a related icon community feed optionally selected within a user's selected zone. In an embodiment, seller or services ratings may be provided along with online payment or bidding systems. In an embodiment, users may benefit from having access to a dedicated icon online services or marketplace to buy and sell items and services relating to specific professional profile elements (i.e., particular passions, activities, and interests). These icon aggregated communities of experts and enthusiasts provide a specialized and optimized services, buying and selling market.

In an embodiment, the secondary descriptor information for an icon and/or icon group may include a measure of the level of the user's participation and status in that group as well as other tools such as a full group view or join feature and further information.

In an embodiment, a user's status as a “founder” 312A of a business group may be displayed in the professional profile. According to an embodiment of the present invention, a founder of a new icon group has the ability to control and administer some of the information, secondary icon pop up information, invitation functions, group purpose and mantra, number and sex of members, media, news, advertising and posts for that group or control all sub group or local chapter formations.

In an embodiment, the professional profile 300 may also include a section relating to one or more goals 320 established by the user. Under a “goals” category 320, a user may display an interest in pursuing a professional aspiration that he or she has not achieved yet. For example, two professionals with the same interest and same overall goals for that interest are identified as highly compatible. An indicator may be configured to differentiate the icon as a goal, thereby indicating that the user has not attempted that activity or is a novice. The “goals” category 320 may also attract other users who have the same ambition or allow users of a concierge service (described below) or advertisers to find users or groups who may want specific instruction, offers, news, information or services to help them reach an icon displayed goal. A user goal status feed and status summary may also be displayed allowing another user quicker access to all or a portion of a user's posted and accomplished goals and recent scheduled activities from their profile. In an embodiment, users may be matched and search based on their goals associated with an icon and other secondary information.

In embodiments of the present invention, any of the icons in the professional profile 300 may be independently: interacted with used for contact, searching, professional communities, social technologies such as social gaming and video chat and broadcasting, invitations or calendar events related to that specific icon profile element or be selected by the users of the professional network icon system in order to input and/or review additional information associated with the selected icon (i.e., the secondary descriptors). For example, as shown in FIG. 3, professional profile includes a patent and licensing expert icon included in the “My Expertise & Education” section of the professional profile 300.

By selecting the “patent & licensing expert” icon, a pop up window 318 or revealing action is generated and allows the viewer to review secondary descriptors and further tertiary media and information related to that icon set by the user which are associated with the patent & licensing expert icon. For example, the patent & licensing expert icon and associated pop up window 318 or revealing information may communicate multiple secondary descriptors and pages including, for example, a text-based description 318A, a skill level indication 318B, a goals indication 318C, and/or an indication related to “references” 318E for the user (optionally including a link to further information relating to the references). In an embodiment, the pop up window 318 also allows other users to contact the user to inquire about engaging in that icon activity with the user, using, for example, the “send invite” icon 318D or request to a user to attend a blog community, video or text chat session based on that icon element subject.

In an embodiment, any of the secondary descriptors may also be displayed in connection with the icon as it appears on the main professional profile display. For example, the futurist trends icon is associated with a level indicator 308A (e.g., a passion level or skill level indicator) which is visible from the main professional profile display, without requiring a pop up window to display the secondary descriptor information.

In an embodiment, secondary descriptors that may be associated with an icon may include, for example, a voice recording, animation, music file, picture, text box, link, badge, ranking, rating or video. In an embodiment, the pop up window 318 may appear above an associated icon, in a designated area on the display, or an animation may appear (e.g., an animation wherein the icon appears to flip over), or in a text box on the screen with a user's desired action or more descriptive icons appearing along with an actionable pallet of user contacting methods, referrals, purchasing methods, communication messages, system related actions, or other suitable tools that relate to that icon element type. In an embodiment, the viewer may control what level of detailed information he or she wishes to view by selecting a user's icons. The icon system may also report where a user currently is present or located within the icon system or environment.

In an embodiment, the user's customized selection of icons for inclusion in his or her professional profile and any associated secondary descriptors may be associated with an icon search term for use in determining a user's desired specificity for compatibility. For example, a less specific icon within a category may result in a broader compatibility outcome (e.g., results in a greater number of matches) as compared to a highly specific icon and secondary descriptors including a zone preference.

The described additional skill, passion and/or preference detail may remain “covered” unless the viewer touches or otherwise interacts with a top-level icon. In an embodiment, presenting the secondary descriptor information in a convenient manner dramatically shortens the time a user spends evaluating a professional profile and determining compatibility. For example, a user may request to view matches or only show results based on certain key secondary descriptors (i.e., use the secondary descriptors as a filter). The resulting sorting or consolidation process may be user-driven or performed by the professional network icon system in order to provide consistent profiles and results for all users and device types.

In an embodiment, a user may post icon-sized pictures, images or videos regarding a specific icon or group, under a main icon element to provide more specific information. For example, a user may display a “Wall Street” icon as a favorite movie on their professional profile. Highlighting that brand registered icon may display the user's favorite clip, play a sound file from “Wall Street”, or display scenes from that movie or a presentation of the “Wall Street” movie may be provided by a paid advertiser including an optional link to purchase the movie. In this method, brands and advertisers may potentially embed exclusive secondary content with their associated icon element. Further examples include a community group icon for “Wall Street” memorabilia buying and selling. One having ordinary skill in the art will appreciate those additional embodiments may be employed for formatting, stacking, organizing, functionality, linking and displaying secondary descriptor information.

In an embodiment, the professional profile 300 or profile elements may be certified, as indicated by the “certified” designation 322 (which may be shown in a main header area or in connection with a specific icon, such as, via a pop-up window associated with the icon). A user and his or her associated professional profile may be certified to demonstrate that the professional profile is authentic and represents the underlying user with which the profile is associated by any suitable method known in the art (e.g., via an algorithm check of independent information used to authenticate the identity of a user, by charging a fee to obtain certified status, etc.). The “Certified” designation may also be an indicator that the user has been rated highly by several different members who know the user, have been a colleague or utilized their product or service, or have scheduled an activity with the user and reported positive interactions.

According to embodiments of the present invention, the professional profile (e.g., professional profile 300 in FIG. 3) may be used by the professional network icon system to determine compatibility of the user associated with the professional profile 300 with other professional profiles and/or employment opportunities maintained by the professional network icon system. In embodiments, many traditional and interpretive methods of compatibility may be selected by a user or the professional network icon system's matching algorithms. Embodiments of the present invention include, but are not limited to, icon system or user-selected preset and customizable match algorithms including interpretations, theories, random or other derived assumptions of compatibility compared to direct icon compatibility such as having a matching or complimentary Icon and skill level requirement. In addition, matching criteria may be derived from the community practices or based on norms within that community. A professional network icon system-selected or user-selectable compatibility option wheel or list may be offered that contains traditional and less traditional profile matching customized for the professional community, such as, for example, business-related traits, personality traits, business theory, industry association, business personality, social standing, tests, games, lifestyle, psychology, ideology, surveys, hobby and interest personality traits, team, complimentary or opposing compatibility, team compatibility, interest category hierarchy matching, fantasy, games and other measures based off usage, and or icon or use profile selections.

According to an embodiment of the present invention, the skill level indicator (e.g., 318C in FIG. 3) is displayed in order to allow viewers further clarity on compatibly based on their unique preference. For example, two dentists with a large variance in specialty or genre style may not be interested in joining a common association despite having a common profession. In this example, a “dentist” icon associated with a text-based description box, media file, or other indicia indicating the user is a “orthodontist” may be displayed to more narrowly describe a preference, specialty, or skill.

In an embodiment, the icons included in a professional profile may be categorized or marked as an “active”, “priority”, or a “past” interest, position, profession, or association. A past interest or inactive indicator may infer the person's skills are probably lacking or they are not very interested in participating in that area at that point in time. Unlike static text profiles, users may frequently change these categories and priorities due to travel, changing jobs, or based on having a new ambition or preference. This information may be used to increase compatibility with another user if the interaction is based on an activity. Frequency indicators (e.g., how often or frequently a user participates in an activity) may also be provided in the first level (e.g., a top level or initial display of a professional profile) of an icon or professional profile view or a second level of the icon or professional profile view (e.g., following an interaction with the top-level icon). For example, an expansion of an icon associated with an activity may include second descriptors such as a next available date or typical date-related and intensity preference for participating in the activity.

In an embodiment, a passion level indicator may also be associated with an icon as a user may be passionate, but lack skill or experience. In operation, after selecting an icon for inclusion in the professional profile, a user may select a status identifier such as a “Student”. “Intern”, “Beginner”, “Expert” in place of a skill rating, and also provide an indication of a passion or skill level. In an embodiment, a “Student” or “Beginner” indicator is associated with the icon to differentiate it from a user who is an expert or veteran in the underlying professional profile element. In embodiments, students or beginners may be invited to events and enjoy the icon group community and news feeds configured for that audience, such as, for example, video broadcasted classes or tutorials. In an embodiment, users may search profiles based on their preference for a certain skill, intensity preference or passion level for an activity, profession, or area which may be communicated via an icon, primary page indicators, and/or a secondary descriptor.

In an embodiment, the professional profile shown in FIG. 3 may be formatted, styled, organized and arranged in a resume-type format. Advantageously, use of the icon-based professional resume eliminates reading volumes of verbose text field based resumes and presents information in a graphical, pictorial and keyword vantage point of a person's business acumen and accomplishments. Further detail and specificity is presented upon selection of the individual icon profile element. In particular, the icon-based professional resumes lend themselves to quick global comprehension and effortless readability on a mobile device, particularly those having a relatively small display area.

According to embodiments of the present invention, an icon-based professional profile presents an info graphic like profile allowing presentation of abstract, conceptual, pointed, pictorial, keyword, and high level display of a person's skills, experience and business personality whereby each selected profile element contains rich and uniformed specificity. Unlike the substantial limitations of a text based resume, the icon-based resume's image quality, selection, content, organization and secondary information provides new insight into a candidate to assist in an evaluation of the candidate's qualifications.

In an embodiment, an icon-based resume provides a business-related summary and enables a viewer (e.g., a recruiter, client, customer or hiring entity) to make an efficient over and via selecting an icon element, further secondary and precise assessment of the user's qualifications. The professional profile provides valuable insight into a person's work strengths and style not possible with text only presentation.

According to embodiments of the present invention, various personality and business skill tests may be administered in connection with the professional network icon system resulting in icon pallet result suggestion and/or associated icon based certifications.

In another embodiment, a user's profile elements, either individually, grouped, or in combinations, are compared to other users profile elements to determine a significant repeated occurrence of associations between icon profile elements, whereby the system may determine and suggest these other related or “missing” system icon element skills, activities, hobbies, interests, and the like. The icon element suggestions may be search or posted and based on common user icon profile element trends and associations and other associative element preference theories. In a basic exemplary process example, four users are determined to have 8 common icon elements collectively; user five has 5 of these common icon elements. The system stores and posts a recommendation of the 3 missing new icon elements to user five.

FIG. 4 illustrates exemplary interfaces of a mobile device application of the professional network icon system, according to embodiments of the present invention. As shown in FIG. 4, an exemplary professional profile 400 may be customized a smaller display on a mobile device including basic professional network icon system functionality 402 and a toolbar 404 for video chat, media sharing and the like. As previously discussed, the icon categories 406 offer an easy-to-read, informative, and independently actionable profile overview with efficient attribute viewing capabilities compared to current lengthy, static and non-interactive or integrated text-based profiles and preference information for any social group genre and associated technology.

According to embodiments of the present invention, the professional network icon system enables users to source business and other products and services efficiently by zone, while also providing national or international opportunities.

In an embodiment, as shown in FIG. 4, the exemplary professional profile screen 400 includes a patent & licensing expert icon 414 which is actionable to display second descriptors and contact means and methods associated with the icon 414. In this example, a secondary descriptor including a text-based description 408 of the user's patent and licensing experience is displayed. In addition, various statistics associated with the patent & licensing expert icon 414 are displayed, including a passion level indication and a skill level indication 410 and an earned “total reputation points” score 412 (e.g., a statistical assessment of the user's reputation or expertise level relative to a professional profile element which may be calculated and/or determined based on various information collected and maintained by the professional network icon system).

For example, using a touch screen device and a mobile application associated with the professional network icon system, the user may gesture swipe in the area of 406 to view additional icons in that category. A mobile professional profile viewer, as shown, allows a user to instantly retrieve and quickly review numerous professional associates' profiles before or during a business group meeting scheduled with the calendar function. According to an embodiment of the present invention, the first page or first icons are chosen as the most important to the user, or have been most utilized as determined by the system as the most skilled or passionate interests. Other icon profile lists or pages may be created, managed and customized by a user for participation via the professional network icon system or via APIs with different sites and communities.

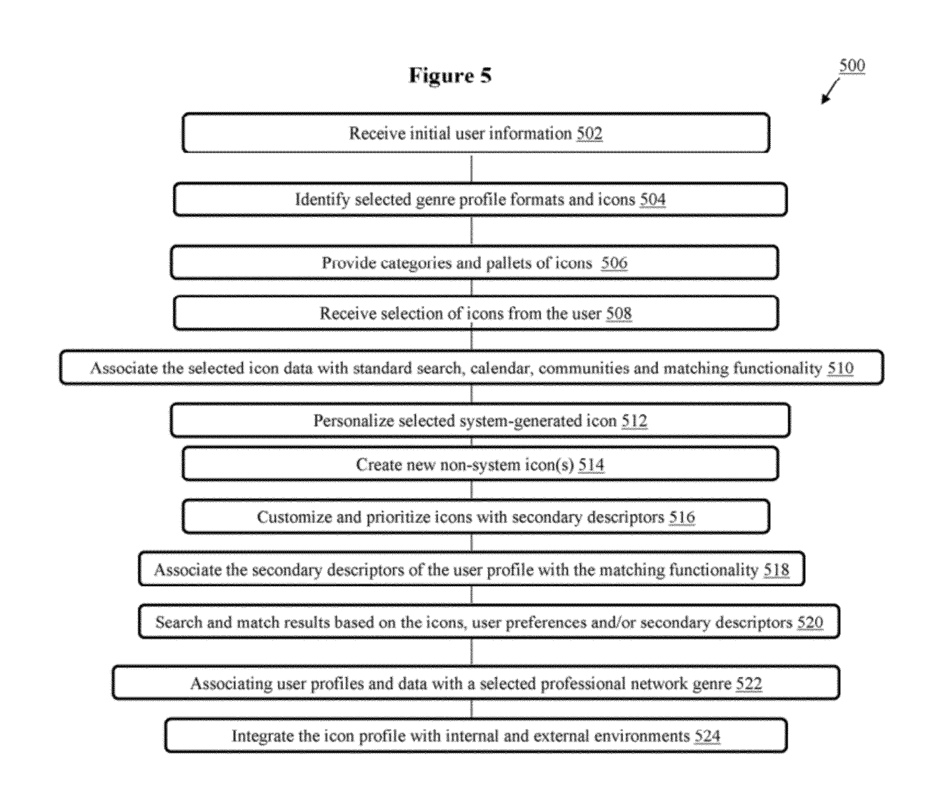

FIG. 5 illustrates an exemplary method 500 for generating an icon-based professional profile, according to embodiments of the present invention. As shown in FIG. 5, method 500 includes receiving initial user information from a user, in block 502. The initial user information may include, but is not limited to, basic background information of the user (e.g., sign-up information such as a name, address, etc.), an indication of a professional network genre (e.g., the genres described in connection with FIG. 2), and/or a selection of an icon profile creator system or functionality.

In block 504, the professional network icon system identifies the professional profile format and library or of icons associated with the selected genre identified in block 502 (or a general format and library if no genre is selected/specified by the user). From the identified library of icons, a pallet of icons including icon categories is presented to the user, in block 506.

In block 508, the professional network icon system receives from the user a selection of multiple icons from the pallet of icons for inclusion in the professional profile. In an embodiment, the user may also be provided with profile category or format options, an optional icon or text based survey, game, test, content suggestion, or other guidance that may be used by the professional network icon system to generate profile content and icon suggestions or suggestions regarding prioritization of selected icons for the user.

In block 510, the professional network icon system associates, links, connects, relates, etc. the professional profile including the associated icon data with one or more functional areas or environments of the professional network icon system which are configured to use the professional profile. For example, the one or more functional areas or environments may include, but are not limited to, the professional network icon system's searching functionality, business calendar functionality, community categories, professional employment, services, products and networking environments, technologies, and groups, and the compatibility/matching functionality.

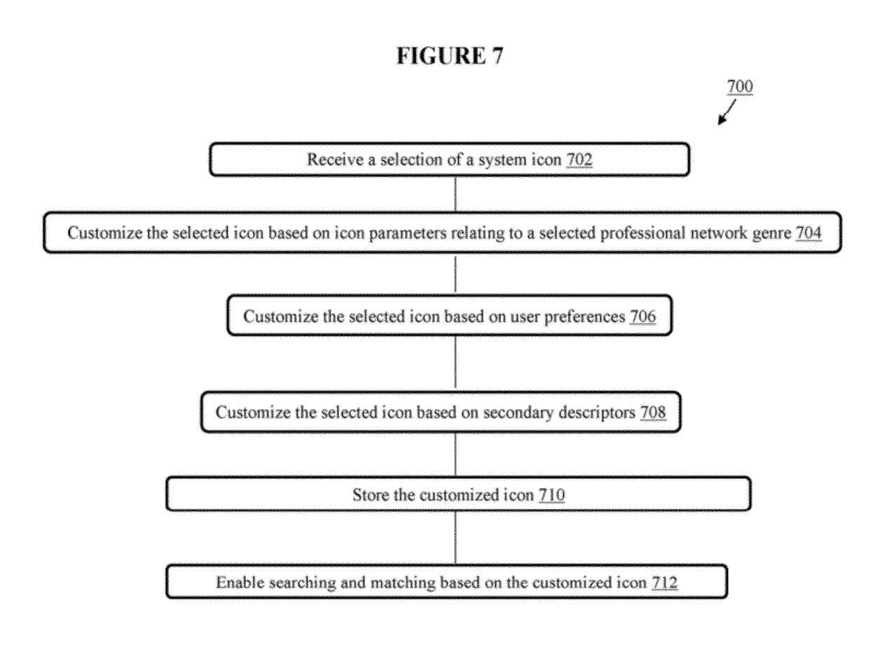

In an embodiment, in optional block 512, the professional network icon system may customize and/or personalize a system-generated icon based on user preferences, information and/or parameters received from the user, as described in greater detail in connection with FIG. 7. For example, the user may personalize or upgrade the appearance, features, network capability or functionality of an icon according to his or her preferences. Brand and/or advertising-based icons may also be selected, wherein the content and functionality may be partially provided and controlled by the advertiser. In block 512, the professional network icon system may customize an icon or professional profile in accordance with user-established preferences, such as, for example, privacy preferences, matching preferences, community preferences, business calendar preferences, etc. In addition, the professional network icon system formats the professional profile and/or icons included in the professional profile in accordance with the user preferences.

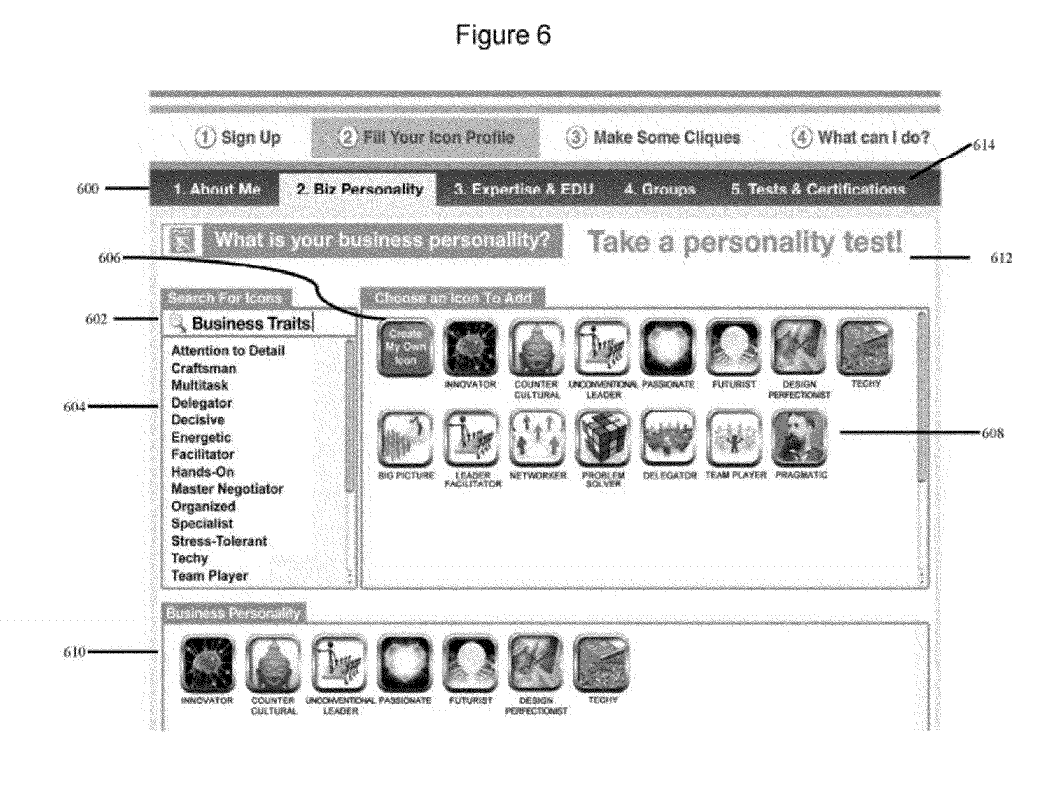

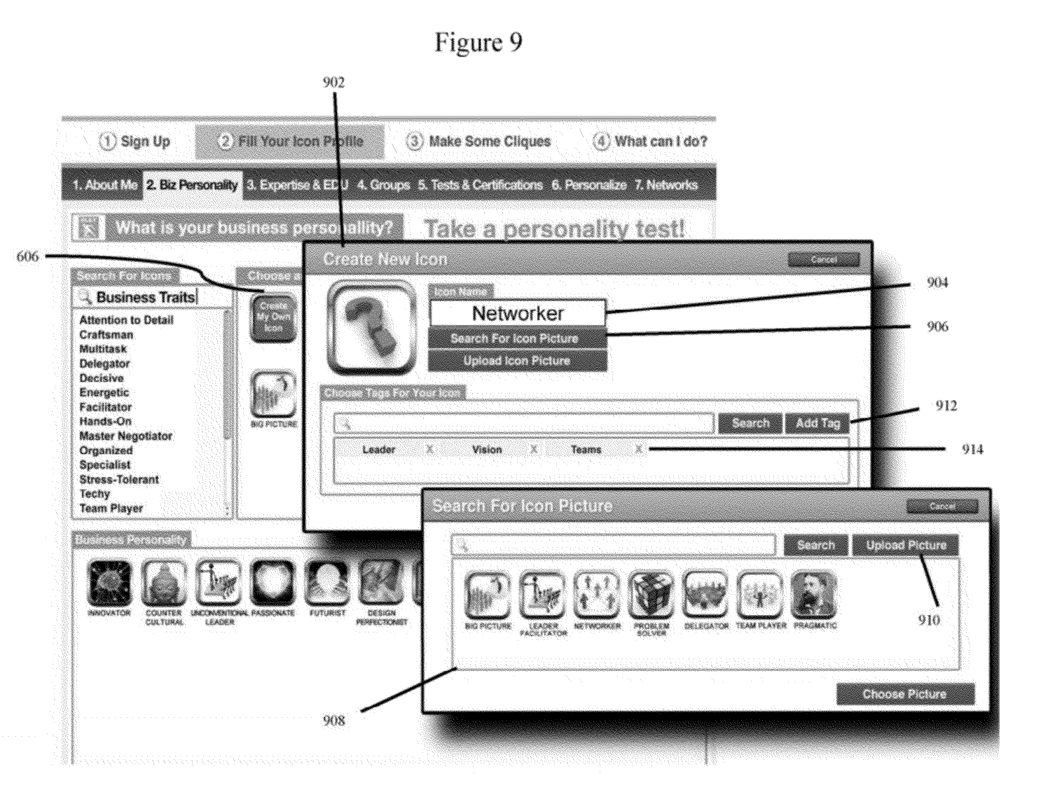

In an embodiment, in optional block 514, the professional network icon system may create a new non-system icon (i.e., an icon not included in the initial library maintained by the professional network icon system) based on information, preferences, and parameters received from the user, as described in greater detail below with respect to FIGS. 6 and 9.

In an embodiment, in block 516, the professional network icon system customizes and prioritizes one or more of the selected icons in the professional profile with secondary descriptors, as described in greater detail in connection with FIG. 7. According to this embodiment, in block 518, the secondary descriptor information associated with the professional profile is stored and may be used in connection with the compatibility/matching functionality or in connection with any aspect of the professional network icon system as described with system icons.

As shown in block 520, the professional network icon system is configured to search a database of professional profiles and match a first professional profile with other professional profiles or groups based on the icons of the first professional profile, other potential theoretical associations, user preferences, and/or secondary descriptors associated with the professional profile within the professional network icon system.

In block 522, based on a user selection of one or more genres, or professional network environments or technologies in block 502 or a later selection of a genre by the user, the professional profile and associated data may be added to the selected professional network genre system(s) or professional network environment(s) and technologies for use therein.

In optional block 524, the professional profile may be distributed or exported to an internal environment (i.e., an environment or subsystem of the professional network icon system) or an external environment (i.e., an environment that is not maintained by the professional network icon system) for integration with a third party application or web services or for use in inviting other potential users to use the professional network icon system.

FIG. 6 illustrates an exemplary interface of an icon-based professional network system displaying an icon profile creation tool configured to perform the method 500 shown in FIG. 5, according to embodiments of the present invention. In an embodiment, after signing up by providing basic user data (e.g., providing personal information, providing account preferences and/or uploading a profile photo or video), the user is prompted to select icons based on the category headers 600 (e.g., icon categories such as “About Me”, “Biz Personality”, “Expertise & Education (EDU)”, “Groups”, “Tests & Certifications”) and icons provided by professional network icon system. In the example shown in FIG. 6, the user interacts with a setup process within the “Biz Personality” section of the icon profile creation tool. In this example, the user wishes to search for and select icons relating to business traits 602. A pallet of icons, each with a unique ID, possibly embedded with secondary media, linked to search terms, related icon elements, traits, associations, inferences, keywords, and other tag matching data is presented to the user in the display or pallet area 608.

If, for example, the user selects the “Organized” icon from the pallet 608, the “Organized” icon 608 appears in the “Business Personality” display area 610 and become part of the professional profile along with any/all previously selected icons.

As shown, the pallet of icons in display area 608 includes an icon 606 that may be used to create a new music-related icon under this genre that is not found in the system-generated list. If the user wishes to create an icon she will select the “Create My Own Icon” icon 606 and open a new icon creator or group icon creator system based on the properties of the desired icon element, shown in FIG. 9.

As illustrated in FIG. 9, in association with the “Create My Own Icon” icon 606, a pop up window 902 is displayed which allows the user to define a new user-generated icon. In an embodiment, the user may define parameters associated with the user-generated icon, such as an icon element type with certain secondary representative functionality and structure, an icon name, an icon name or descriptor 904 (e.g., “Networker”), and/or search for or select an image, animation or representation for the icon. Upon selection of the icon picture search button 906 icon, a pop up window may appear which includes a pallet of existing images 908 that may be used for the icon or enable a user to upload a different image 910 from various internal or external media devices, image databases, search sources and other related resources. In an embodiment, the user may use an “add tag” button 912 to add tags and/or keywords, and the like 914 associated with the icon.

Returning to FIG. 6, in an embodiment, once the user has selected all of the business trait icons, the user may rank and/or order their interests based on their. In an embodiment, the user may establish the icon priority by dragging or highlighting his or her selected icons and placing them in a desired order. It is to be appreciated that the user may easily edit his or her professional profile including the icon rankings as their ranking and/or other secondary preference changes.

In an embodiment, the professional network icon system profile creator tool may include a testing tool (e.g., represented by an actionable “Take a personality test!” link 612 or accessible via the “Tests & Certifications” tab 614) which provides a user with a test used to assist the user in identifying one or more icons for inclusion in the professional profile. In an embodiment, the test results may be stored in the user's professional profile (e.g., in a section associated with the “Tests & Certifications” tab 614) and may be used by the professional network icon system for compatibility and matching purposes and/or displayed to other users.

FIG. 7 illustrates exemplary method 700 relating to generating a customized icon-based professional profile, according to embodiments of the present invention. One having ordinary skill in the art will appreciate that the blocks shown in FIG. 7 represent optional parameters, preferences, and/or information that may be received from the user and/or determined by the professional network icon system for use in customizing one or more icons and/or a professional profile.

In block 702, a selection of an icon is received by the professional network icon system. The selected icon may be associated with icon information including, but not limited to, icon header display text, an icon identification number, a media element (e.g., an image or video), an indication of other associated icons, secondary preferences, and one or more searching and/or matching terms, tags, and/or keywords.

In block 704, if a professional network genre has been selected, the professional network icon system identifies any icon parameters (e.g., features, structure, format, requirements, etc.) for the selected icon based on the selected professional network genre. The professional network icon system then customizes the selected icon based on the genre-related icon parameters.

In block 706, the professional network icon system receives user preferences provided by the user relating to customization of the icons for the professional profile. Exemplary user preferences associated with individual icons and/or the professional profile may include, but are not limited to, selecting a display preference when an icon is touched or selected, setting matching preferences including whether the user allows matching invitations, adding associated gear and/or gear preferences, automatic user-to-user matching, using an icon for icon communities, profile privacy settings (e.g., identifying portions of a professional profile for inclusion in a public profile and/or a private profile), preferences relating to the sharing of icon updates, and setting preferences with respect to concierge services and/or advertisements. It is to be appreciated that additional user preferences may be utilize to custom icons and/or professional profiles in the professional network icon system. One having ordinary skill in the art will appreciate that in certain instances, block 706 is optional, in that a user may not identify any user preferences for use in customizing the selected icon.

In block 708, the professional network icon system receives one or more secondary descriptors associated with the selected icon. Exemplary secondary descriptors associated with individual icon element types and/or the professional profile may include, but are not limited to, a selection of a professional profile element type (e.g., a “seeking services”, “fan”, “participant”, “priority”, “key skill” “service”, “seeking employment” etc.), a selection of a level indicator (e.g., a passion level indicator, a skill level indicator, etc.), a “quick view” symbol or indicator for inclusion on a top level professional profile page or display, a text-based icon description, active or inactive, select for use in icon professional communities, one or more goals associated with the selected icon and whether those goals are displayed in a goals feed, adding a business calendar association to the selected icon, indicating a frequency preference (e.g., active participant, former participant, retired participant, etc.), associating gear, equipment, industry affiliations & associations, recognitions, badges, brands with the selected icon, associating additional content (e.g., videos, links, applications, pictures, historical data, etc.) with the selected icon, and adjusting the placement and priority of the selected icon in the professional profile.

In an embodiment, a secondary descriptor may be associated with an icon which indicates whether that icon should be used as part of the user's resume (e.g., a version of the professional profile particularly suited and/or customized for use as a resume). It is to be appreciated that additional secondary descriptors may be utilized to customize icons and/or professional profiles in the professional network icon system. One having ordinary skill in the art will appreciate that in certain instances, block 708 is optional, in that a user may not identify any user preferences for use in customizing the selected icon.

In block 710, the customized icon is stored in the icon database and the searching and matching functionality is or may be enabled based on the customized icon (e.g., the customized icon may be used for searching and matching purposes), in block 712.

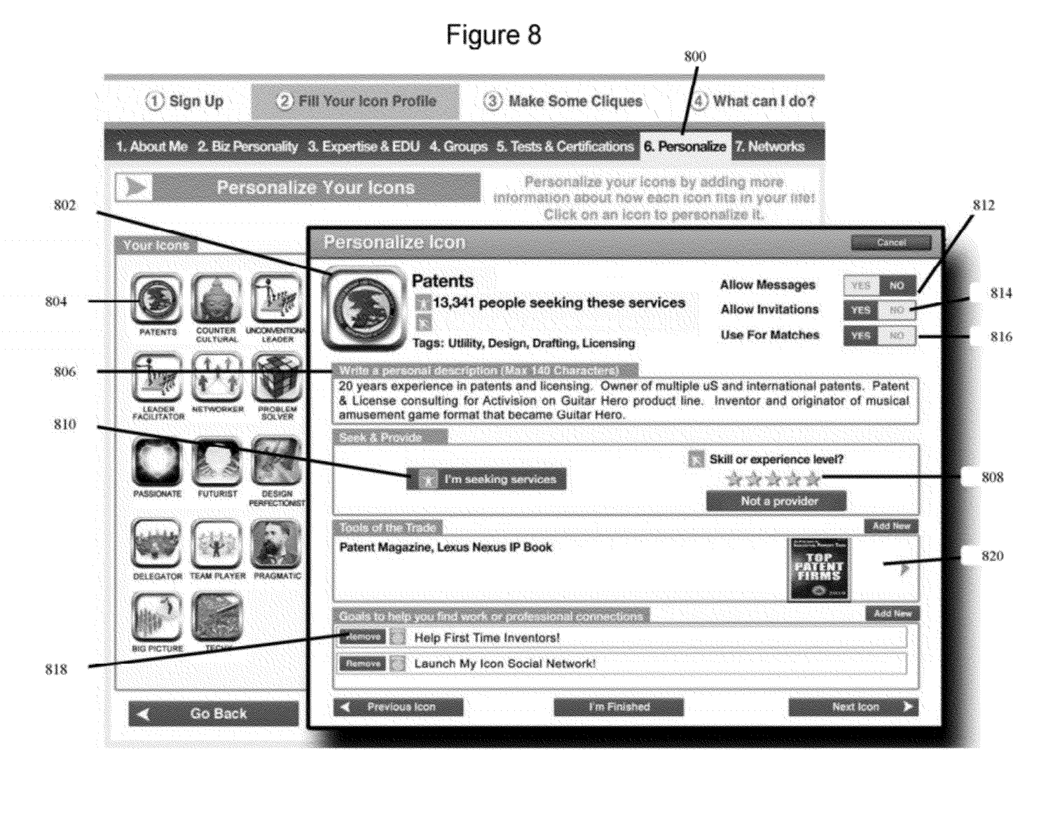

FIG. 8 illustrates an exemplary interface of an icon-based professional network system displaying a personalized icon including user preferences and secondary descriptors associated with the icon, according to embodiments of the present invention. In the example shown in FIG. 8, the personalized icon 802 may be generated according to exemplary method 700 which may be initiated by interacting with “Personalize” tab or button 800.

In an embodiment, the personalized icon includes user preferences and/or secondary descriptors, such as icon-related preferences, sub-icons (e.g., associated icons), goals, media, security preferences and further user or system customization. The user preferences and secondary descriptors allow the user to display further information in various forms in accordance with their preferences, dislikes and skills relating to a professional profile element which may appear as a pop up or other known or state of the art displaying techniques when that icon is selected. This information is helpful to a viewer of a profile in determining a match or for learning more about a user's icon data box. Users may also select general or specific concierge or advertising preferences associated with each icon element and secondary descriptor such as a brand or company preference. This information is also utilized by the search engine for more precise searching and matching, for community features and concierge and advertising services.

In this example, the user selects a patents icon 804 for personalization from a group of the user's selected icons. In the icon header, the user may view the total approximate number of users and user types associated with the “Patent” icon within the professional network icon system. It is noted that this number may be filtered based on the selected zone and user compatibility matching. In the icon header, one or more tags may be shown which indicate other search terms related to baseball that is considered.

As shown in FIG. 8, the customized icon includes a text-based personal preference description 806. This text may appear as a pop up or second layer of information from a selected icon of interest. The customized icon may also include a skill and passion rating 808 and a related status 810 (e.g., the “I'm seeking services” status indicator).

In an embodiment, one or more user preferences associated with the selected icon may be set by the user, such as, for example, whether the user allows messages associated with the icon 812, whether the user allows invitations or solicitations associated with the icon 814, and/or whether the personalized icon may be used by the professional network icon system for matching purposes 816.

In an embodiment, one or more user goals 818 related to the selected patents icon may be set by the user, which, for example, may assist in more precise user matching and assist with providing additional icon specific demographic granularity for concierge and advertising users. In an embodiment, the icon-related goals may be shown in a goal summary feed or in an icon pop up. The icon-related goals may also allow the user to track progress of his or her achievements over time.

In an embodiment, the user may associate one or more favorite brands, trade tools or resources, or the like (in the exemplary “Tools of the Trade” section 820) with the personalized icon. The “tools of the trade” information may be used as a means to provide advertising targets, data, and improve advertising results for the user and advertiser. Optionally, users may select from pallets of “official” advertiser brand icons which customized functionality or ‘create their own’. In an embodiment, via the described icon profile creator system, a user may routinely and dynamically update, alter and change his or her profile icons based on their past activity schedule, career changes, seasonality, new skill or experiences, evolving preferences, location, and changing professional lifestyle. Notifications of these icon profile changes or status changes may be pushed to friends or into the general icon community and news feed.

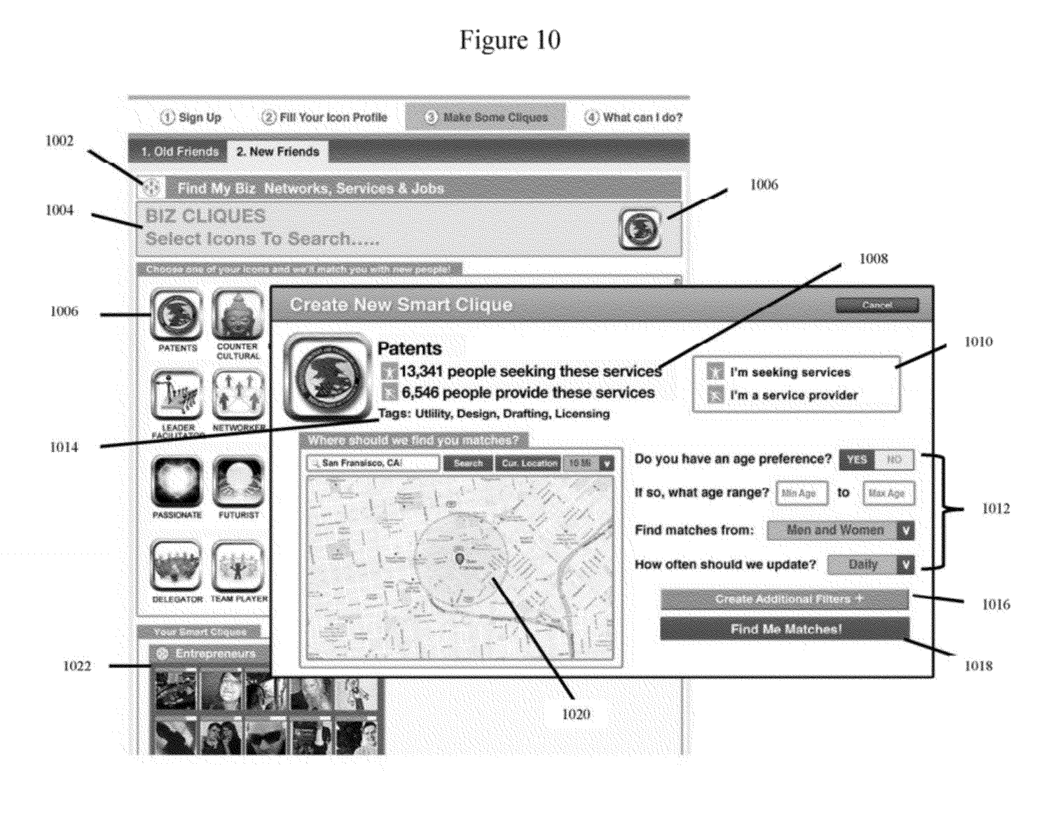

FIG. 10 illustrates an exemplary interface of an icon-based professional network system displaying an exemplary “smart clique” or “biz clique” user group identifier and creator tool, according to embodiments of the present invention. As shown in FIG. 10, the professional network icon system is configured to perform “biz clique” matching and grouping. In the example shown, a user may initiate the business clique generation process by interacting with the “Find My Biz Networks, Services & Jobs” section 1002 within the “Make Some Cliques” tab, as shown in FIG. 10. In an embodiment, the professional network icon system may provide a searching tool 1004 which allows a user to indicate the one or more professional icons to be used to identify an existing business clique or create a new business clique. In an embodiment, the user may select one or more icons 1006 and/or keywords for use in matching within a particular community. In this example, the user indicates that he or she wishes to identify or form a clique within the “patents” icon community 1008.

In an embodiment, the user may select a type 1010 (e.g., a person seeking services, a person providing service) that he or she wishes to use to identify potential clique matches. In an embodiment, the user may indicate searching filters, preferences and/or criteria 1012, such as, for example, an age range preference, a gender preference and an update frequency preference. In an embodiment, the user may create his or her own searching filter 1016. In the header of the icon, one or more tags and/or keywords 1014 associated with the professional profile element may be listed.

In an embodiment, the user may select a preferred geographic zone 1020 for the icon-based community. Smart Clique results may also factor overall icon and other compatibility in addition to system or user selected search preferences. The smart clique matching system is also utilized in the network's social communities and technologies. After results are posted, the user may save the search preferences and or individual members in their smart clique groups, such as the saved smart clique associated with an “entrepreneurs” icon community 1022. The cliques allow faster and more discrete communication for an icon activity or other grouping. In addition, cliques may also receive prioritized community interaction and communication with one another in the site. Upon completion of the fields associated with the clique creator tool, the user may cause execution of the tool by clicking on an actionable button or link, such as, for example, the “Find Me Matches!” button 1018.

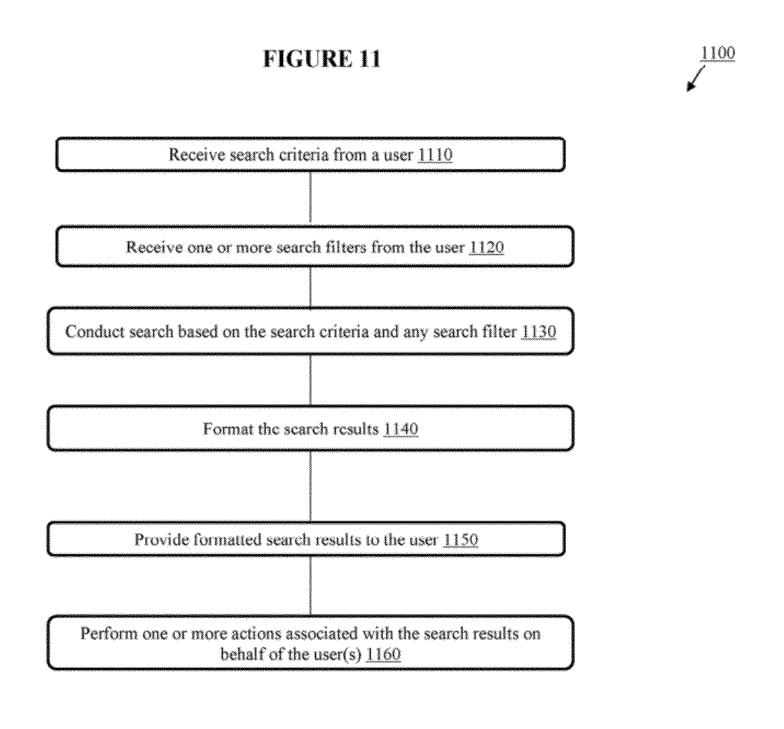

FIG. 11 illustrates an exemplary method 1100 for searching within the professional network icon system, according to embodiments of the present invention. As described above, the professional network icon system maintains multiple professional and business profiles in an icon database. Each of the professional profiles includes various data and information that may be used to identify the professional or business profile during a search, the information including, but not limited to, the user-selected icons, search terms, associated icon data (e.g., secondary descriptors), and user preferences. In an embodiment, the professional profile information is used to compare multiple professional profiles, identify potential employment opportunities, and/or compare the professional profiles with search criteria provided by or to the professional network icon system. Advantageously, according to embodiments of the present invention, the uniformity in the professional profile creation process, described above, optimizes the professional profile searching mechanism and the accuracy of the identified search results.

These primary and secondary icons and text box descriptors may be associated with a search term or terms for use with the search system. Viewing the associated search term or text descriptor when selecting an icon helps users select the icon that best describes each personality or icon group trait. A user may be allowed to add brief clarification text and/or secondary icons to further describe that interest or preferences within that interest. Other associated media and information may also be included and viewed by the searcher. These secondary user keywords may be used in search and matching algorithms. These icons may also provide a brief description of their meaning for other users viewing the icon, which may be displayed by pressing the icon or by a text descriptor below the icon which may also be the keyword search term.

In an embodiment, the matching system or searcher may utilize a higher category topic or complimentary topic or interest in order to match other users and groups. For example, a doctor icon may have a search tag of “general practitioner,” or “pediatrics doctor.” Matching a general practitioner and a pediatrics doctor may result from a desire to form a referral network. In another matching algorithm example, a doctor icon may also be tagged as an “entrepreneur” and a “professor,” as secondary traits for matching purposes. Users may also select from a pallet of secondary traits related to the business traits, group, activity or profession that best describes them. Each profession may have secondary traits assigned for matching to others based on a user's top interests, activities, or the like.

The exemplary search method 1100 is initiated by a user. In block 1110, the professional network icon system receives search criteria from the user. The search criteria may be any information that may be used by the professional network icon system to identify other professional profiles, including, but not limited to, one or more icons, one or more icon category/groups, one or more business calendar events, users in community technologies, community types or genres, one or more keywords, one or more tags, one or more secondary descriptors, one or more user preferences, and any combination of multiple search criteria elements. In block 1110, the search criteria may be received from a user in multiple different ways, such as, for example, by conducting an icon-based search [e.g., a search of a community associated with a particular icon (i.e., an icon community)], by conducting a business calendar-based search, by conducting a business clique or group-based search, by conducting a geographic or map-based search, a community search, and the like. For example, the user may conduct a search based on a baseball icon together with her preference for a certain skill or passion level for playing baseball an activity which may be shown with an icon.

In block 1120, the professional network icon system may receive one or more search filters from the user. The search filters may be used by the user to further specify, define, narrow, and/or focus a particular search. Exemplary search filters may include, but are not limited to, a smart-clique filter, additional search criteria, a “zone” or geographic limiter, an icon filter, a secondary descriptor filter, a user preference filter, an experience level filter, a qualifications filter, professional community filter, a resume filter, and the like. One having ordinary skill in the art will appreciate that in certain instances, block 1120 is optional, in that a user may not identify any search filters. It is noted that the user may customize and tailor a search using various combinations of search criteria and search filters to identify search results having a desired level of granularity.

In block 1130, the professional network icon system conducts a search of the icon database based on the search criteria and any applicable search filter(s) to identify a set of search results. In embodiments of the present invention, any suitable searching algorithm may be employed in order to identify and/or locate, and individually or mutually tag one or more professional profiles matching the selected search criteria and applicable search filter(s).

In block 1140, the professional network icon system formats the search results in accordance with search result display parameters. In an embodiment, the search result display may be in any suitable format including, for example, a map-based view, a professional community view, a list-based view, a business calendar-based view, etc., a report including compatibility results (e.g., professional profile compatibility scores, business calendar compatibility scores), assessments, a result acceptance option, a common or related icon list (e.g., a list of icons shared by the first user and the one or more professional profiles identified by the search), a ranked list of the professional profiles in the search results based on one or more of the compatibility or compatibility theory results, a presentation of the search results including indicators identifying particular characteristics of the search results (e.g., an indicator identifying a common “high priority” icon match, a common status match, a “high/highest compatibility” match, a common friend/group/clique match), a comparison of secondary descriptors, etc.

In an embodiment, the user may select one or more preferred formats for the search results. Alternatively, if the user does not specify a preferred search result display parameter, the professional network icon system may use a default view or display format. Compatibility results may appear when causally viewing other users' profiles, as described above. In an embodiment, the professional profiles identified in the search results may be scored and aggregated into a ranked icon-based result listing or aggregated into social environments. In an embodiment, the professional network icon system may determine a compatibility score based on a combination of all of the search criteria elements entered by the first user (e.g., the searched icon(s), secondary descriptors, user preferences, etc.) to determine an overall compatibility score.

In block 1150, the formatted search results are provided to the first user. Following provisioning of the search results to the user, the professional network icon system may perform various actions associated with the search results based on instructions received from the user, in block 1160. In an embodiment, in block 1160, the first user may view a full professional profile of any of the professional profiles identified in the search results (e.g., by touching or clicking on the desired professional profile). In block 1160, the professional network icon system may transmit a communication (e.g., e-mail, chat request) or an invitation (e.g., an icon-based invitation, an event-specific invitation, a community invitation, a group invitation), a general connection request (e.g., a request from a user to connect with another user), or a resume from the user viewing the search results (i.e., the searcher) to one or more of the users identified in the search results. In addition, in block 1160, the professional network icon system is configured to perform actions on behalf of the one or more users (e.g., the searcher and the users identified in the search results) such as, for example, receiving the communication and the searcher, such as, for example, performing an instruction to accept or modify an invitation, add invitation data to the business calendars of the users, join the selected community, processing payment for any fee-based transaction (e.g., a concierge service), generating any reminders associated with an invitation, process any feedback associated with the communication, interaction, transaction between the users and add the feedback to the applicable professional profiles, etc., and executing a request from the searcher to add one or more users identified in the search results to a custom clique or confirm certain smart clique matches.

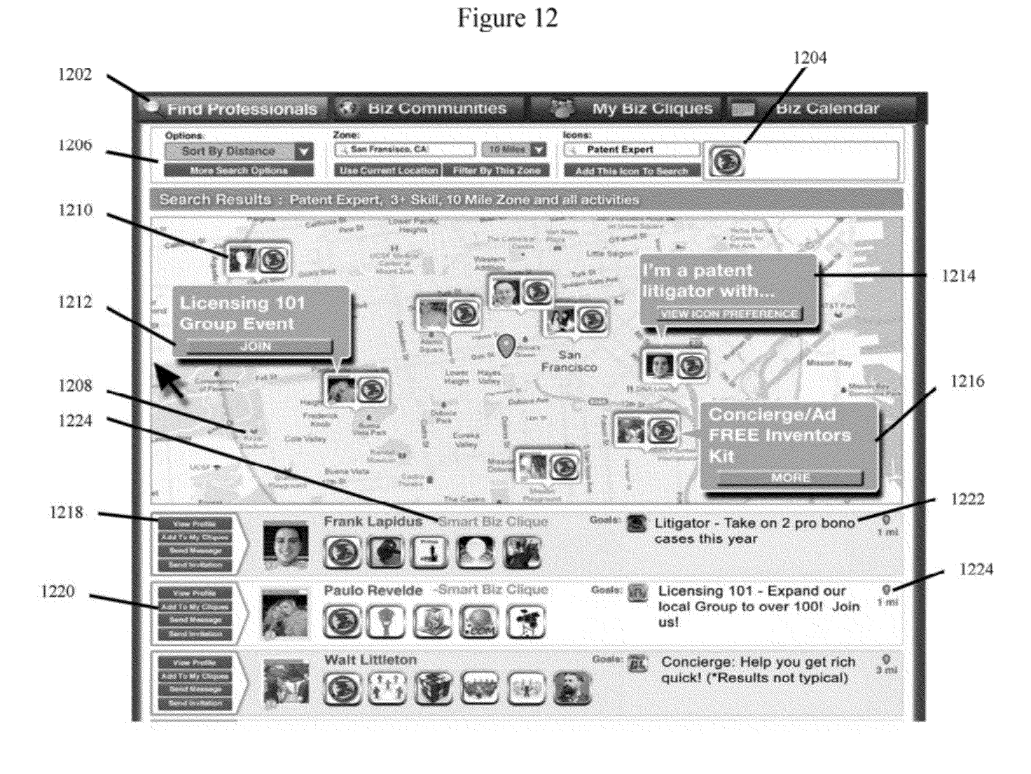

FIGS. 12-16 illustrate exemplary interfaces of the professional network icon system displaying exemplary search results and associated user actions relating to the search results, according to embodiments of the present invention.

FIG. 12 illustrates an example of a search performed by the professional network icon system, according to embodiments of the present invention. In the example shown in FIG. 12, a user initiates a search in the “Find Professionals” environment 1202 of the professional network icon system. The professional network icon system receives the search criteria including icons 1204 (e.g., a patents icon) and a search filter 1206 including a geographic limiter or zone (e.g., a ten mile zone centered on San Francisco, Calif.). In an embodiment, a user may prefer to only input their street name, and not their exact address number, which would in turn display a general area on a map result. In another embodiment, during this process, a user may also search for matching and related concierge services, group events, ads or deals, as described below.

In the example shown in FIG. 12, the search results are formatted and displayed in a map format including a map 1208 displaying the zone specified in the search filter 1206. The search results include a number of professional profiles matching the search criteria, such as the professional profile/icon match 1210. In an embodiment, all or a portion of the professional profiles identified in the search results may be highlighted and/or displayed the map 1208. By pressing the highlighted icon, additional matching information and statistics may be provided.

In an embodiment, the user may click or otherwise interact with a match to view an associated pop up display 1212. Exemplary information that may be displayed by interacting with a match includes, but is not limited to, an invitation to join a group event 1212, an indication of a user's professional background 1214 configured to optionally provide a brief comment regarding a business calendar match or next availability, and an advertisement, promotion, or coupon associated with the search result.

In an embodiment, a user may post a similar invitation in their associated patents icon online community blog which may post this event in an open invitations blog feed for others with related patents icon including a “seeking a patent attorney” subset to view to attract more attorneys. This general structure and functionality may be used for any genre of icon posting.

In an embodiment, a listing 1218 of the professional profiles identified in the search results is provided by the professional network icon system. The professional network icon system may be configured to highlight and list the best overall match icons based on estimated total compatibility and or by the user's selected search and compatibility preferences. In some cases, non-professional compatibility icons may be considered in compatibility score or utilized by the searcher to determine a most compatibly result. Non-professional compatibility is an important factor in professional relationships. In an embodiment, the listing 1218 may be prioritized to list the professional profiles for users that are identified as members of a “Smart Clique” 1224 associated with the searcher. In an embodiment, a professional profile may include compatibility measurements or scores 1220 which in this example, visually indicates the degree of compatibility via a color-coded bar or other score/match indicator. In an embodiment, the listing 1218 may include a goals indication and description 1222 and/or a proximity indicator 1224 associated with one or more professional profiles identified in the search results.

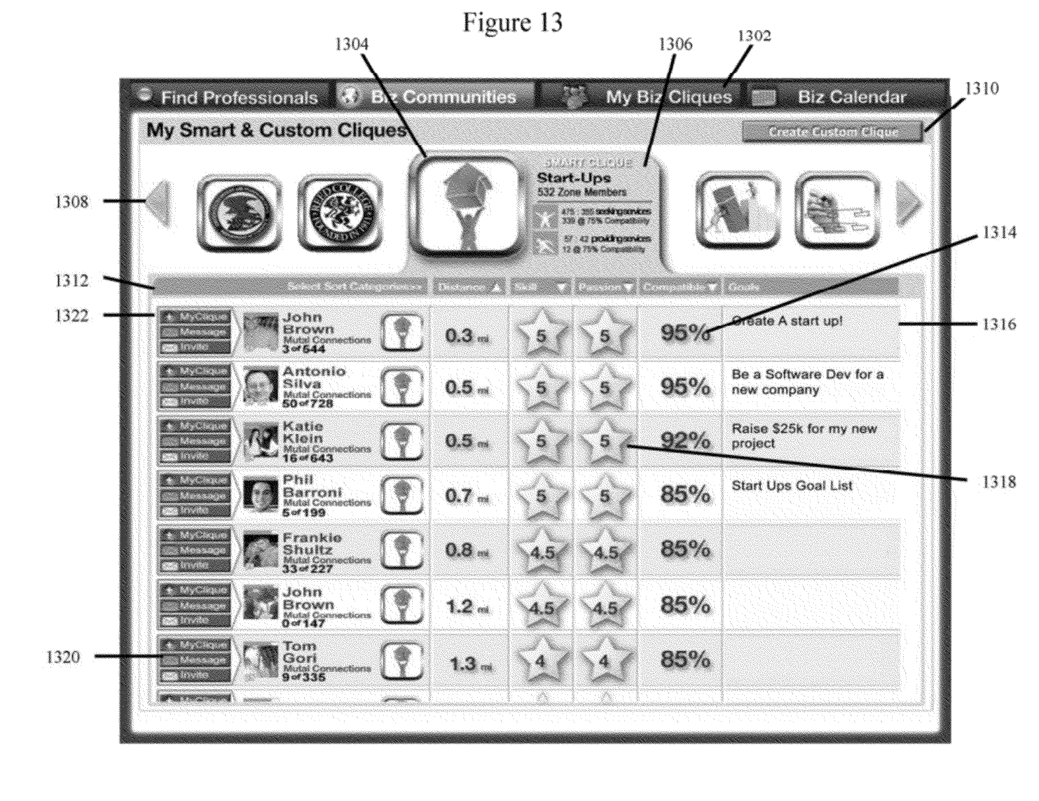

FIG. 13 illustrates an exemplary interface of the professional network icon system displaying exemplary search results generated by the professional network icon system, according to embodiments of the present invention. In FIG. 13, the exemplary search results page results from a search conducted within the “Biz Communities” environment 1302 of the professional network icon system. The exemplary user initiating the search is a member of a start-ups icon-based smart clique 1304. In an embodiment, the start-ups icon-based smart clique header 1306 includes various statistics associated with the clique. The exemplary user is also a member of a number of other smart and/or custom cliques, and may conduct a search for professional profiles within any of the cliques or icon profile elements identified in the scrollable banner 1308 shown in FIG. 13.

In an embodiment, the user may create a custom clique 1310 including one or more of the professional profiles identified in the search results, and the custom clique would be associated with the searcher's professional profile and stored by the professional network icon system.

As shown in FIG. 13, the search result listing may be sorted according to one or more criteria 1312 (e.g., by category, distance, skill indicator, passion indicator, compatibility, goals, etc.). In the exemplary search results listing, a number of different data points and information may be displayed to the searcher, including, for example, one or more compatibility scores 1314 associated with the professional profiles identified in the search results, one or more goals associated with the icon activity and user 1316, a passion or skill level indicator 1318, and a geographic distance between a location associated with the professional profiles identified in the search results.

As shown in FIG. 13, the searcher may take one or more actions with respect to a professional profile identified in the search results, such as, for example, sending a message 1320 or resume to a user associated with a professional profile, adding (or inviting a user to join) a user using a “My Clique” link 1322 associated with the user.

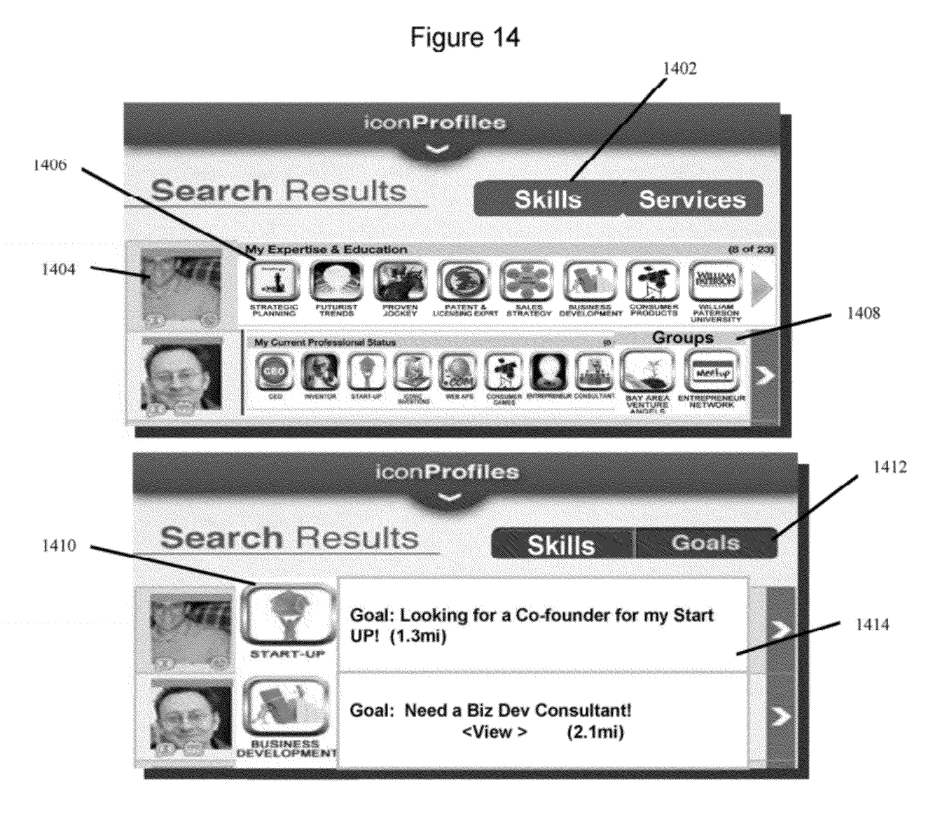

FIG. 14 illustrates exemplary interfaces formatted to mobile application-based embodiment displaying exemplary search results identified by the professional network icon system in response to search criteria including one or more secondary descriptors, according to embodiments of the present invention. The portion of an exemplary interface on the top of FIG. 14 illustrates exemplary search results presented and sorted by the professional network icon system in a skills-centric view 1402. As shown, each professional profile 1404 may be presented with a corresponding listing of his or her expertise & education 1406 identified and displayed to the searcher to enable the search to identify a user having the desired skill set, expertise, education, and/or professional affiliations or groups 1408.

In an embodiment, as shown in FIG. 14, the search results may be presented and sorted by the professional network icon system in a goals-centric view 1412, as shown in a portion of an exemplary interface on the bottom of FIG. 14. As shown, each professional profile is presented with a corresponding listing of his or her goals 1414 associated with a professional icon (e.g., the start-up icon 1410) identified and displayed to the searcher. In an embodiment, a description of the one or more goals 1414 may be provided as part of the search results.

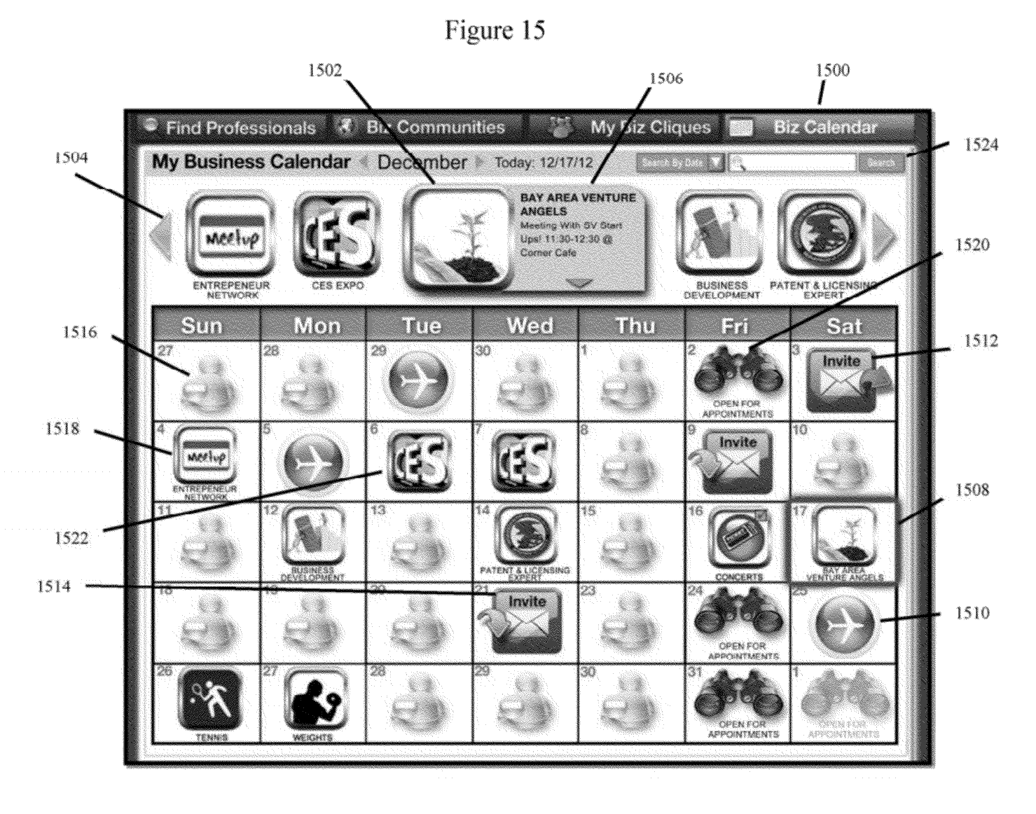

FIG. 15 illustrates an exemplary interface of a professional network icon system displaying an exemplary icon system integrated interactive icon-based business calendar (or “Biz Calendar”) 1500, according to embodiments of the present invention. The icon-based business calendar 1500 provides an icon profile element integrated and image-based communication of scheduled events, availability for time slots/dates, and unavailable time slots/dates or private activities 1516 identified by a user and/or the professional network icon system. According to embodiments of the present invention, the business calendar 1500 may be used to view and create events, view and match open times, schedule meetings, and view a new associate's potential availability, and send an invitation based on a particular icon.

In an embodiment, a user may add a new business calendar event to his or her business calendar 1500 or review existing business calendar events by selecting an icon (e.g., the Bay Area Venture Angels icon 1502) from the multiple icons 1504 in the professional profile. In this example, the user selects the Bay Area Venture Angels icon 1502 in order to highlight or identify any associated events on his or her business calendar. The selected Bay Area Venture Angels icon 1502 includes a header or pop up identifying information 1506 relating to any business calendared events and preferences associated with the selected icon. In addition, in this example, the corresponding event 1508 associated with the selected Bay Area Venture Angels icon 1502 is highlighted in the business calendar.

In another embodiment, the professional network icon system may generate the pop up associated with the Bay Area Venture Angels related event 1502 in response to a user interaction with the date on the business calendar 1500 including the Bay Area Venture Angels related event (e.g., December 17^{th}). In another embodiment, a current day may be automatically highlighted (e.g., when the current day is December 17^{th}) when the user opens the business calendar and any associated events may be highlighted in a pop up window (e.g., the Bay Area Venture Angels related event 1502).

As shown, the business calendar 1500 may include multiple icons and various indicators relating to the icons and events. For example, airplane icon 1510 may indicate traveling days whereby the professional network icon system may be configured to locate or notify new friends and activities in the city of travel or more precisely at or near the user's hotel.

In FIG. 15, exemplary business calendar entry 1512 includes an outgoing invitation (i.e., an invitation sent by the user associated with the business calendar) to another user (as indicated by the arrow indicator on the right hand side of the invitation icon).

In FIG. 15, exemplary business calendar entry 1514 includes an incoming invitation (i.e., an invitation received by the user associated with the business calendar) from another user (as indicated by the arrow indicator on the left hand side of the invitation).

In an embodiment, the business calendar may also contain icons to represent scheduled events, such as an entrepreneur network meeting 1518 which is open to other's participation. By pressing or putting a mouse over icon 1518, a user may view additional secondary details such as, for example, time, location, other participants, comments, and/or information associated with the meeting. In an embodiment, the business calendar may include an icon 1520 representing a day and/or time the user is available and actively looking for an activity to do with a business associate.

Various other indicators may be used in connection with the business calendar to communicate and represent information to one or more viewers of the business calendar 1500, such as, for example, an icon/indicator indicating an open invitation that has not been accepted, an icon/indicator indicating an accepted group activity, a skill level, expertise, professional background, etc. associated with a business calendared event.

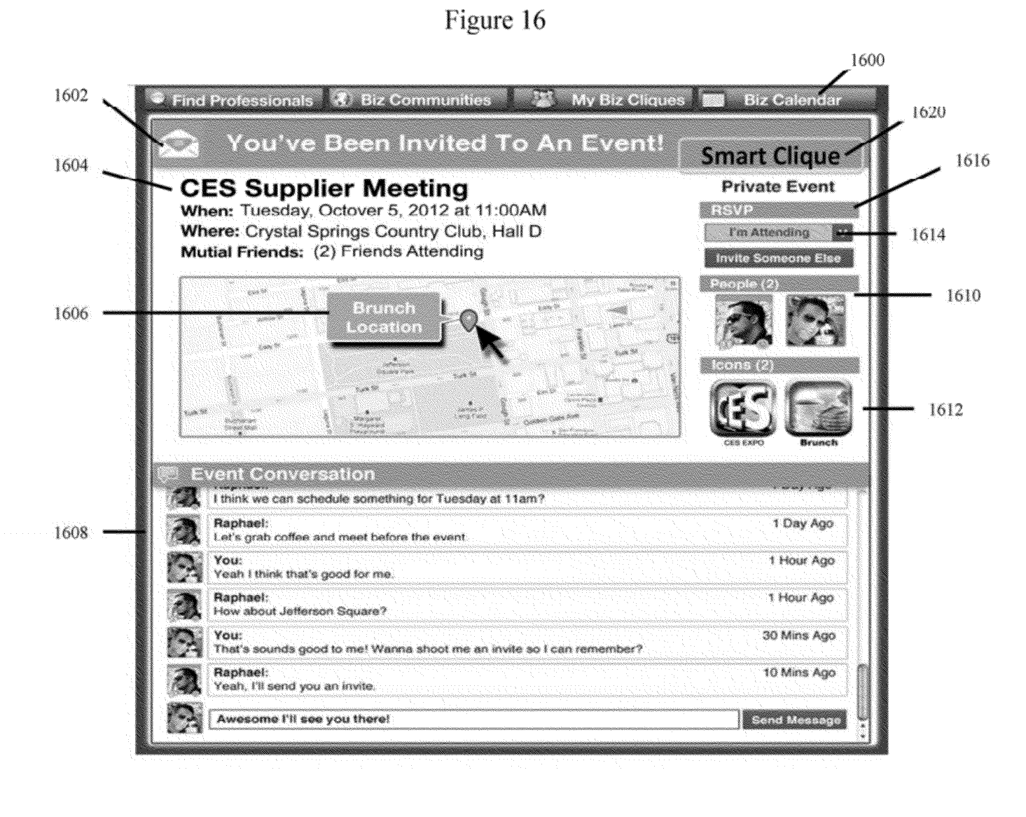

In the example shown in FIG. 15, the user may interact with an icon in the business calendar to view additional information associated with the event and/or access additional functionality of the professional network icon system. For example, if a user clicks on the Consumer Electronics Show (CES) 1522, additional detail relating to the CES event may be displayed to the user, such as the display shown in FIG. 16.

As shown in FIG. 16, an exemplary interface of the professional network icon system is provided which displays an exemplary invitation and chat associated with the “CES” icon on the calendar in FIG. 15, according to embodiments of the present invention. In the example shown in FIG. 16, the invitation may be viewed with the business calendar environment 1600 or system generated match result. As shown in FIG. 16, the exemplary invitation 1602 may include various event/invitation related information including, but not limited to, a name of the one or more events 1604 (e.g., the CES Supplier Meeting), time of the event, a link to a community event, and location of the event, a map identifying the one or more event locations 1606, a conversation or chat associated with the event 1608, an indication of the participants in the event and their respective icon profiles 1610, one or more icons representing the type or nature of the event 1612 (e.g., the CES expo and brunch icon), a status indicating whether the user is attending 1614, an actionable link to invite one or more other users to the event and/or RSVP to the invitation 1616, and a privacy setting associated with the event 1618 (e.g., the indication that the brunch is a “Private Event”). In an embodiment, an actionable button may be provided to allow the user to generate a “Smart Clique” 1620 based on the event. According to embodiments of the present invention, activities/interest may be best suited for one-on-one participation by the users or require a group or certain minimal level of participation which may be set as required or preferred criteria for a group event or invitation.

Embodiments of the present invention also offer a business calendar feature button that determines and presents schedule conflicts by showing a color-coded indicator, for example. A user may open a business calendar to view potential conflicts or an icon indicator may provide a free or booked indicator for that time slot. Once accepted, the icon activity is added to the user's business calendar publicly or privately and in some cases the user may suggest and forward the activity or event to their friends or others. In an embodiment, a referral icon (not shown) may contain written or unique icon-based recommendations to increase site usage or refer a friend to also participate in the event. Users may view a public version of another user's calendar in order to select a date and time for a suggested activity. Calendar activity may be tracked, displayed and aggregated and summarized for use by the users and system. Lastly, calendar functions may be used to attract specific advertising and concierge offers based on selected icon activities, zone and availability.

In embodiments, users may check into icon locations, activities and events allowing other users to potentially locate and join them. According to an embodiment of the present invention, the icon system may create an activity history log and rating, with user comments and added media that may be viewed by the user or other members within the community. In an embodiment, users may earn status, icon badges, in-community status or perks for the number of check-ins for their icon activities or for sending invitations to other members.

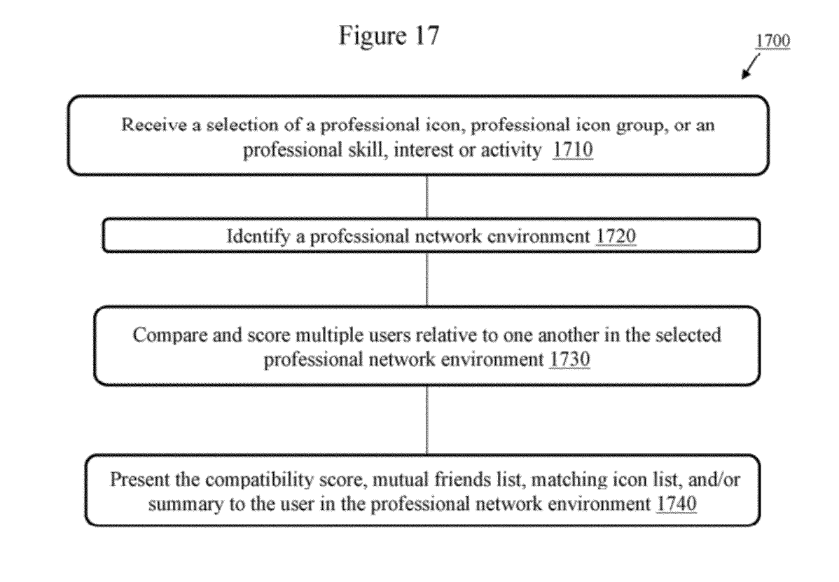

FIG. 17-19 illustrate an exemplary method 1700 for using a generated icon-based professional profile system in multiple professional network environments and various professional network technologies, according to embodiments of the present invention. In an embodiment, the professional network icon system associates a professional profile with one or more internal environments (i.e., environments within the professional network icon system) and/or external professional network environments (i.e., third party professional web services and/or applications). In an embodiment, the association and/or integration of the professional profile system with the one or more environments may be based on the professional profile's icon community preferences, Smart Clique preferences, matching criteria and/or preferences, or the user's zone preferences. In an embodiment, the icons and associated information (e.g., secondary descriptors and user preferences) of a professional profile may be used to determine compatibility of the user with other user's in the different environments.

According to an exemplary method 1700, the professional network icon system receives a user selection including a professional icon of interest, a professional icon group, a professional icon skill, interest, activity, or the like, in block 1710. In block 1720, the professional network icon system identifies a professional network environment type with which the user wishes to have his or her professional profile integrated/associated. Exemplary professional network environment types according to embodiments of the present invention include, but are not limited to, a professional social network, a resume and employment site, an independent contractor site, a text-based blog or chat, a forum, a video chat or conference, a video or movie viewing platform, a marketplace, a social gaming platform, a location-based or local event platform, etc. It is to be appreciated that the professional network environments may be a part of the professional network icon system (i.e., internal environments) or third-party administered services or applications whereby the described icon profile display and system would benefit an existing technology, professional site, or community. (i.e., external environments accessible via an API).

In an embodiment, the professional network icon system may identify the professional network environment type based on a selection received from the user or the professional network icon system may determine or suggest a professional network environment type that contains other users who have a high compatibility with the particular user. In an embodiment, other user with matching or related icons and icon groups may be aggregated by the professional network icon system or an icon profile element into a selected icon community.

In an embodiment, the professional profile may be used to filter the candidate professional network environments for association with the professional profile. For example, the professional profile may include one or more user preferences relating to a desired community size, location, demographic, and those user preferences may be used to filter the candidate professional network environments.

In block 1730, the professional network icon system compares and scores the multiple users in a selected professional network environment based on the professional profiles associated with the multiple users. In an embodiment, the comparison performed by the professional network icon system results in a determination of the search parameters and mutual compatibility of the users within the community and associated compatibility scores are generated.

In block 1740, the professional network icon system presents one or more of the generated search and compatibility scores, an environment summary, a matching summary, a mutual friends list, and/or a matching icon list to the one or more users in the professional network environment. In an embodiment, a mutual compatibility score or other indication may be displayed by the professional network icon system to designate new highly-compatible users, previously confirmed smart clique members, or other previously identified business associates. Mutual priority posting status in an icon social forum or other community may be given to matched users.

According to embodiments of the present invention, certain professional network environments (e.g., online gaming communities, video chat communities, etc.) may advantageously use the professional profile to enhance the respective community experience and encourage socialization, business development, and professional networking.

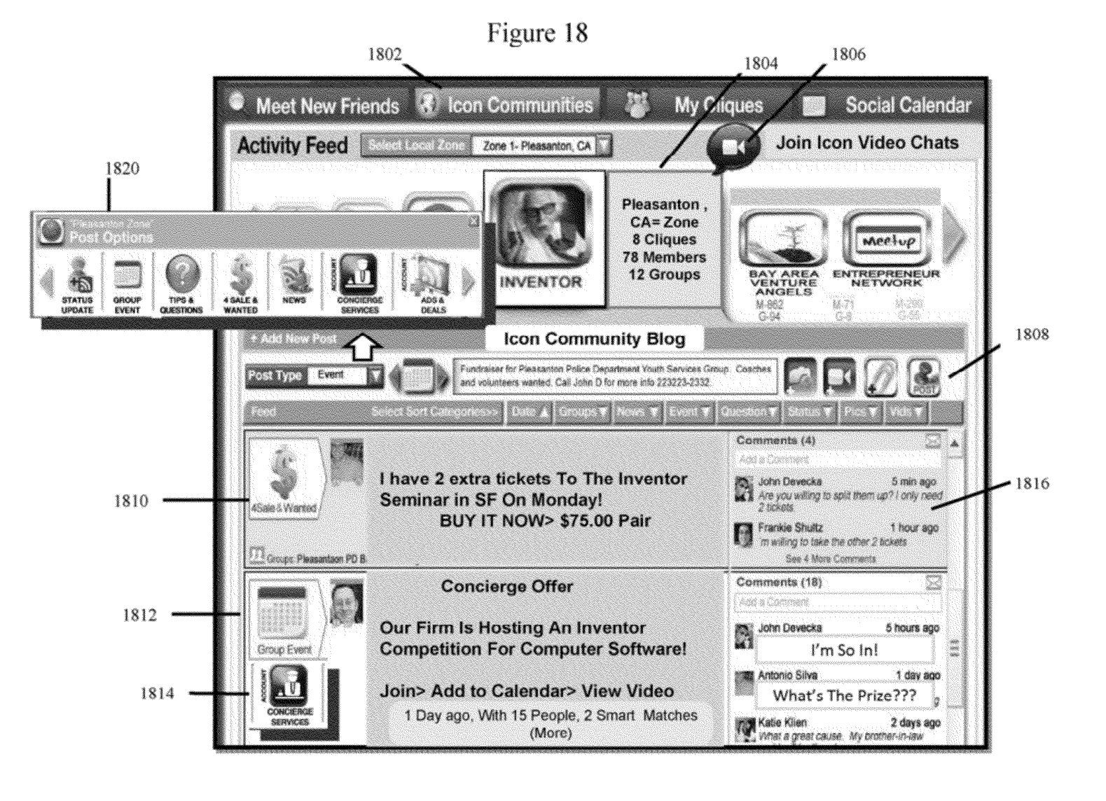

FIGS. 18-20 illustrate important examples of the further integration and new expanded functionally of a professional network icon profile system with various system and external social network environments or employment, networking, events and services networks with various associated technologies, according to a main embodiment of the present invention. Previously described feature sets included various user, group and system directed searching and matching methods for user-to-user or group contact, potentially with the intent to email, chat, meet, or schedule and participate an activity together based on an Icon element or associated icon category.

In addition, the icon profile system may be adapted within various professional networking environments. Online professional communities based on icon elements and subjects offer other equally substantial benefits relating to professional connectivity. According to an embodiment, a suite of social network environments which display and are also linked to users' profile and profile elements and icon network system. Further, icon-connected and specific blogs and social forums offer a user an alternate method of being introduced, finding mutual goals, compatibility and commonalities quickly, chatting, learning, and sharing information with a larger group of matched individuals, even based on a single icon profile element. While in these communities, users' profiles may be compared and matched based on the icon element, compatibility and also potentially other factors, such as a zone. The professional network icon system in combination with these social environments allows users new ways to promote and maintain relationships with a larger collection of icon aggregated and matched users with important matching icon elements and interests.

Conveniently, in an embodiment, in the “icon communities” menu, the professional network icon system offers a list of social network environments and technologies. After selection of the preferred social network environment, such as a blog, social forum, APi link, video chat or billboard, the user may be offered a toolbar that allows instant community aggregation switching from one dedicated icon element or category type to another which may relate to and match some or all the icon elements in their icon profile that have an associated community environment feature.

Also, the professional network icon system provides enhancements to professional networking environments to encourage previously unknown users to share information and identify, communicate with and locate users in these communities with whom who they are highly compatible, even based on factors beyond the unifying icon community element or elements such as smart clique matches.

One method is to compare all user profile data in a community and provide a visible overall compatibility score(s) or revealing an abbreviated icon matching pallet to each user. While users of these communities have dynamic access and may visit, exit, and sometimes even visit different suites in a single social community type, the system may score a user to the community who are live in attendance or those who have temporarily exited and potentially suggest that user visit certain locations where a highly compatible match, smart clique, friend, colleague or other matches are located.

In another method of the invention, a users with matching commonalities, like a smart clique may receive mutual priority features such as placing a smart clique's blog posts in a higher priority compared to less matched users or suggesting that a user visit a certain video chat room within a video chat service where a highly matched user is located. That user may be easily identified by an indicator and commonalities may easily be viewed which will promote new relationship formations. These virtual icon system introductions, notifications and placement techniques intend to create mutual connection opportunities for friendships based around common icon interests.

Use of the icon profile system and method these social network technologies greatly improves user to user personal connectivity when compared to only looking at a user's screen name or having to the time consuming chore of reading an associated and verbose static profile page to delineate personal information and attempt to determine possible commonalities.

FIG. 18 illustrates an exemplary interface of the professional network icon system displaying an exemplary user-selected icon community type. In an embodiment, each icon element a user selected for his or her professional profile may be fully integrated throughout the icon system and each may have an associated dedicated professional community environment as shown. The icon element selected is intended to be the focus of the community content, activity and conversation. A user may select from a toolbar containing other available icon communities derived from the user's profile elements and preferences, according to embodiments of the present invention. For example, a user may access a dedicated icon community blog, an icon community type via an “Icon Communities” tab 1802 or similar link provided by the icon system.

In the example shown in FIG. 18, a user selects a community blog, forum, or billboard professional network environment and subsequently selects an “inventor” icon from the icon elements available in his or her icon toolbar area 1804. The selected icon community statistics are also shown in area 1804. In addition, the user may access a video chat environment 1806 and a video and text chat room 1808 relating to the selected icon community. Many options exist for the user to adjust the social network environments aggregation methods including zone selection and compatibly requirements.

In an embodiment, the icon community blog/bulletin board feed 1808 may be sorted by the user in order to efficiently find desired specific category subject matter or certain user postings pertaining to his or her interest in the “inventor” icon, and may include concierge service-related postings 1810, a business calendar event posting 1812, an indicator relating to concierge services 1814 associated with the icon community, and comments 1816 associated with the icon community chat/bulletin board feed 1808. Users may post blog information under one of these provided category types. As shown, the user may select a desire post type category for inclusion in or filtering of the icon community blog/bulletin board feed 1808 using a “post options” toolbar 1820. By selecting the right or left arrow on the icon community toolbar, new icon element or category specific blog pages will appear. Advertisers and concierge service users may select to post ads, sale items and services in any of these community environments.

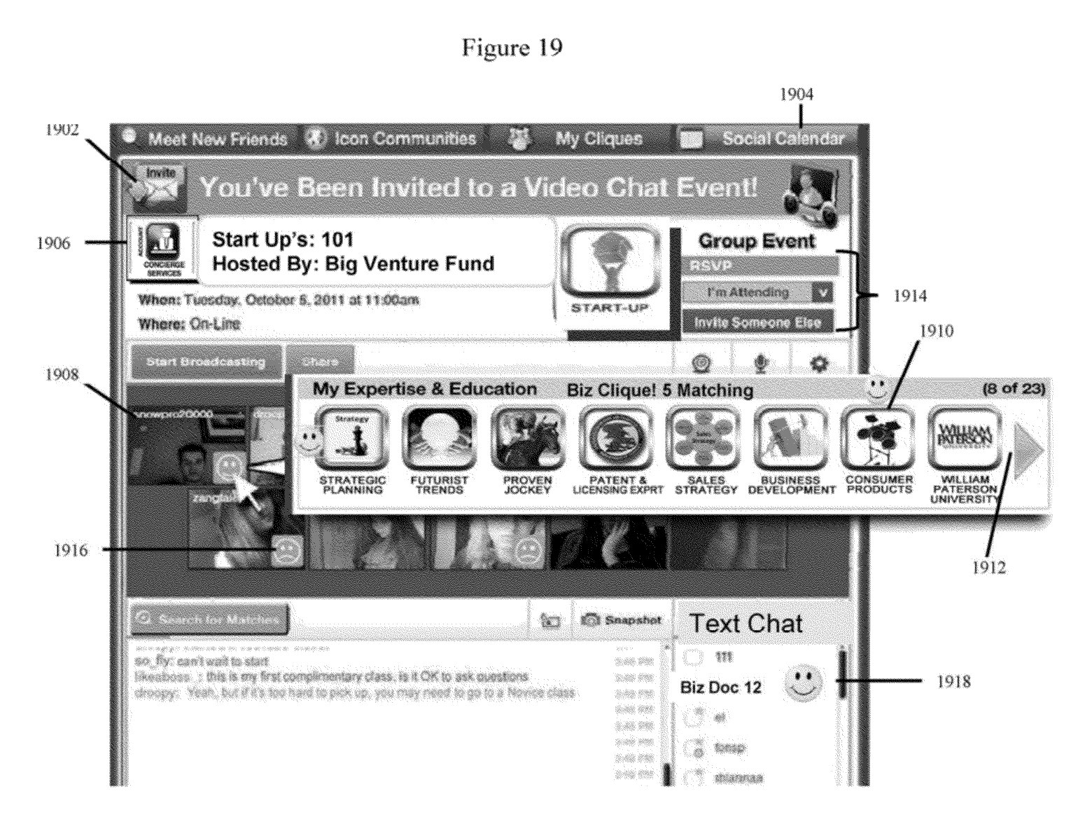

FIG. 19 illustrates an exemplary interface of an icon-based professional network system displaying the integration and/or association of one or more professional profiles in an exemplary video chat, text chat, video streaming, video broadcasting or other video based social technology environment, according to embodiments of the present invention. In an embodiment, the professional network icon system may be configured to associate a professional profile with a professional network environment, such as the video chat environment shown in FIG. 19. As shown in FIG. 19, the video chat functionality may be accessed by a user via a related invitation 1902 which is accessible via the user's icon calendar suite 1904. The video chat may include a header displaying information about the subject of the video chat or broadcast and other associated information including profile information of the chat host or leaders (e.g., the date and time of a schedule video chat), and/or an indication that the event is a concierge service 1906.

Profile images associated with users participating in the video chat may be displayed in section 1908 including an indicator by each matching or related icon. Advantageously, a user may interact with any of the profile images to view all or a portion of the participants' professional profile including one or more compatible professional icon matches as denoted by the smiling face indicator 1910. The icon profile system advantageously allows members to efficiently assess fellow participant's personal information and commonalities while maintaining participation in the event. The professional profile pop up window/display example may include a scrollable list of the icons 1912 in the professional profile. The professional profile pop up window/display may also a banner having additional information relating to the professional profile, such as, for example, a compatibility score, a link or means for further out-of-community communication with a user (e.g., an e-mail link, an invitation), etc. In an example, like a smart clique score, an “emotion” icon 1916 may be used to graphically communicate whether the other participant has a high compatibility with the user (e.g., a smiling face icon represents a positive match while a frowning face icon indicates a low compatibility score). The “smile face” compatibility score prompts users to further explore mutual compatibility and immediately open up subject matter to initiate an interaction and bond. Many compatibility techniques as previously described in the user to user search system may be unitized within the professional network environments.

In an embodiment, the video chat may have an associated text-based chat forum 1918 with the same functionality but without the video element. In addition, the video chat may include one or more fields and/or links which indicates allows a user to RSVP or invite additional users to join the video chat 1914.

In an embodiment, the exemplary invitation and video chat shown in FIG. 19 may be provided to a user in connection with the concierge services provided by the professional network icon system. For example, the concierge services may be configured to send personalized business-related offers to a user or users and or gain additional access to tools and data to further sort user data to improve their advertising effectiveness. For example, if a professional profile includes a start-up icon and a secondary descriptor indicating a need for funding, a local venture capitalist may propose a business funding seminar offer and send the user the invitation 1902 shown in FIG. 19. In so doing, the concierge (e.g., the venture capitalist) may utilize any additional secondary descriptor information in providing the offer, including but not limited to, a user's previous start-up experience, funding rounds, professional experience, icon communities, forums and events.

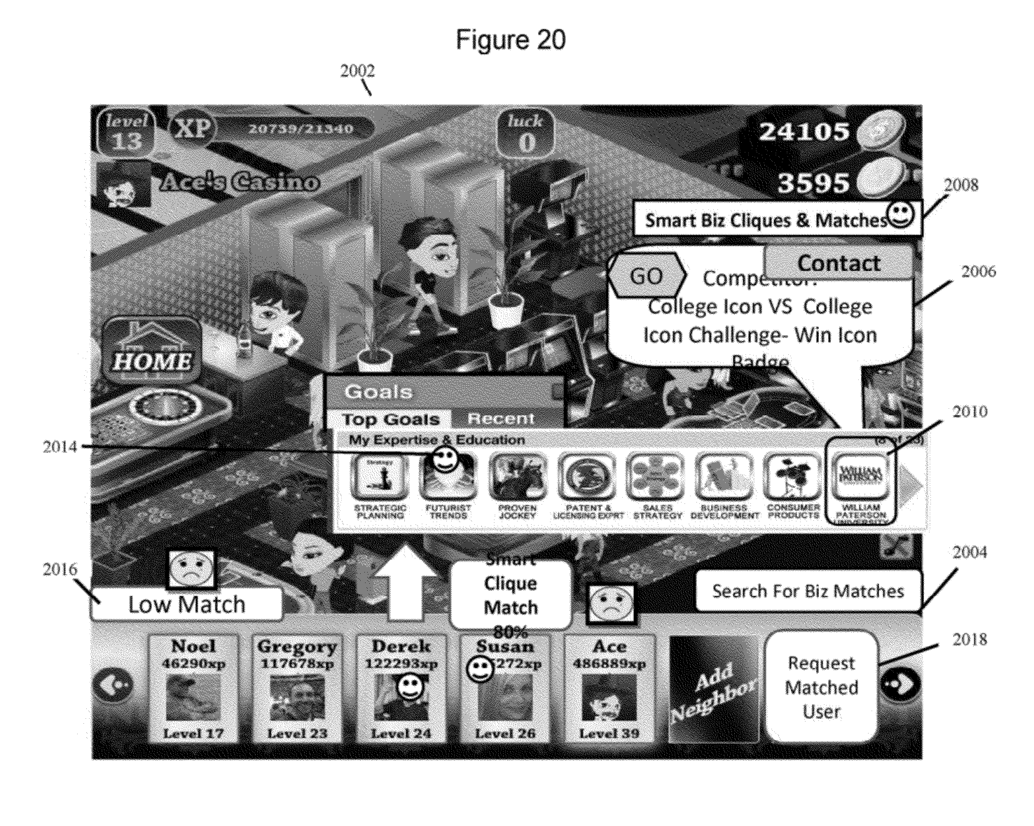

FIG. 20 illustrates an exemplary interface of the professional network icon system displaying the integration and/or association of a professional profile in an exemplary social gaming environment, according to embodiments of the present invention. As shown in FIG. 20, the professional network icon system, professional profile and/or associated data may be integrated into an internal and/or external social gaming environment 2002. In an embodiment, the gaming environment 2002 includes multiple professional network icon system users and their associated professional profiles and data.

In an embodiment, a user may interact with any of the professional profile images shown in the bottom portion of the social gaming environment display in order to view or learn about the user's associated professional profile. Professional users of the social gaming system may enjoy participating in these causal networking opportunities which are provided via a social game experience. In the example shown, the pointer is placed over the icon profile picture associated with “Derek”, and a corresponding pop up window/display is generated including the selected user's professional profile and associated icons. In some gaming communities, professional profiles and matching icons may be displayed to increase business and/or personal connection and understanding. In other gaming applications and communities, professional profiles and data may be integrated into the game experience, selection and grouping of players, gaming content selection and game play, for example.

As shown in the pop up window/display associated with Derek, a viewer may visually determine that he or she has a common William Paterson University icon 2010 and a positive compatibility 2014 with respect to a futurist trends icon, thereby providing a potential basis for a further relationship or connection with Derek. Players may further be matched by zone. By discovering each others' commonalties in a gaming environment, users may desire to socially connect in real life and schedule an activity via the system. In the match list section 2004, a viewer may also visually identify the users in the gaming environment with which they are compatible (as indicated by the smiling face indicator) and/or users in the gaming environment with which they are not compatible or have a low match (as indicated by the frowning face icon 2016). In an embodiment, a user may interact with a “Request Matched User” icon 2018 in order to locate users based on their matching preference as generally described in the icon search system.

In an embodiment, the professional profile within the gaming community may also contain many gaming-specific categories and icons as noted in gaming culture, such as, for example, favorite video games, genres, favorite gaming characters, high scores, gaming achievements, favorite gaming events, gaming groups, and other gaming genre preferences. The data elements may also be integrated within the icon system compatibility matching for a given environment. In addition, social gaming environments may also match players together based on icon compatibility and player matching preferences. In other applications, professional profiles and data may be incorporated directly into game play and competition.

In this example, the professional network icon system displays a section of a user's profile icons whereby certain game mechanics include profile analysis to encourage increased competition or cooperation potentially based on icon professional profile elements. In an embodiment, icon 2006 indicates there is a potential or existing competitive challenge based on a matched professional icon relating to a user's educational background (e.g., the college the user attended/attends). The viewing user and Derek may have different and potentially “competitive” icons or sub-icons associated with their college affiliation.

In an embodiment, scores or badges may be presented based on past competitive performance within one or more gaming environments. In an embodiment, players may also be linked together collectively as a group based on professional network icon system-generated or user-generated created icons or icon associations or elements to compete or perform a task in order to win status points and/or perks for their association. For example, in college icon competitions, users with Stanford University icons may be challenged by users having Yale University icons.

In the example shown in FIG. 20, the user may accept a challenge to compete against the other player by pressing the “Go” button. The challenge may be related to the actual icon interest such as a motorcycle race or be more associated with the theme and mechanics of the video game. The users may also communicate verbal challenges, comments and virtual bets to each other to enhance the competitive environment. These two users may later agree to an “actual” invitation to ride “real” motorcycles together based on the recognition of a real mutual interest provided by the system in this fantasy environment.

According to an embodiment of the present invention, users may initiate a trivia game, for example, provided by the icon system or an application based on their icons, user profile, and/or user preferences, whereby friends or acquaintances may be challenged about trivia derived from their unique user profile data. Scores, credits and awards may be given to determine who has the most knowledge about a person or may guess how compatible users are as determined by the system. In an example, the game may be played online or in person and given as a challenge at a function or party via a mobile device. Any media from that event may be sent and stored for the participants to view or post to the community.

For local mobile users with existing profiles, games may be offered for in-person connections. In an embodiment, users may sync up with local members at an event or gathering, play system created trivia and other games based on a profile data or various compatibility algorithmic results may be offered including local matching of friends, business or those looking for other relationships.

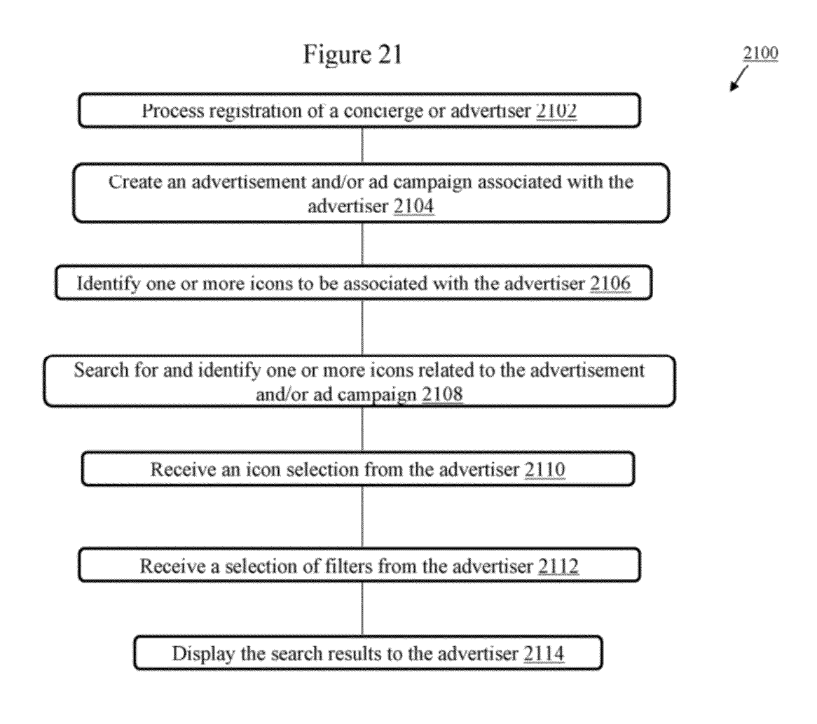

FIG. 21 illustrates an exemplary method 2100 for creating and/or delivering a concierge service or advertisement in the professional network icon system, according to embodiments of the present invention. In block 2102, the professional network icon system processes a registration of a concierge and/or an advertiser (collectively referred to as an “advertiser” in the description of FIG. 21). During the registration process, the advertiser may select one or more professional network genres of interest (i.e., genres to which the advertisers wishes to direct advertisements).

In block 2104, the professional network icon system receives information from the advertiser and creates an advertisement and/or advertisement campaign associated with the advertiser. In an embodiment, the advertisement, promotion, or service offer is created by the advertiser and posted and/or uploaded to the professional network icon system. In another embodiment, the professional network icon system provides the advertiser with a tool configured to enable the advertiser to create the advertisement with the professional network icon system. The advertisement may be defined by various standard ad parameters including, but not limited to, any media type, design, description, format, and the like.

Using an advertisement search module of the professional network icon system, the advertiser may select or be guided to one or more icons or categories of icons from the icon library with which the advertiser wishes to be associated. The selected icons may be used as a basis for directing one or more advertisements from the advertiser. In response, the professional network icon system identifies the selected icon(s) and associates the selected icon(s) with the advertiser, in block 2106.

In block 2108, the professional network icon system searches for and identifies one or more icons related to the advertisement and/or the ad campaign, and presents the identified icons to the advertiser. In block 2110, the professional network icon system receives a selection of an icon from the advertiser and provides information relating to the selected icon to the advertiser (e.g., icon tags, icon description, icon statistics, user and geography statistics, icon keywords, etc.).

Optionally, in block 2122, the professional network icon system may receive filtering information from the advertiser. For example, the filtering information may include, but is not limited to, secondary information or other filters, such as one or more icons or sub-icons, users who generally or specifically request ads or concierge services, a geographic zone, a status (e.g., “Seeking Employment”, “Seeking a Service”, etc.), a skill level, a passion level, one or more goals, an advertiser, business calendar events, branding information such as “my trade tools”, and user preferences (e.g., any user preference associated with accepting advertisements and/or concierge services).

In block 2114, the professional network icon system displays the search results including one or more professional profiles, icons, icon communities, cliques, events, and the like to the advertiser. According to embodiments of the present invention, the advertiser may perform various actions with regard to the search results provided by the professional network icon system. In an embodiment, the advertiser may select particular professional profiles, social community or profile environments, direct-to-user ads vs. public billboard ads, icon communities, events, and/or cliques to serve as recipients or intended targets of the advertisement and/or ad campaign. Optionally, the advertiser may eliminate or remove one or more of the elements included in the search results. In an embodiment, the advertiser may review one or more of the professional profiles identified in the search results.

In block 2116, the professional network icon system receives a selection of one or more advertisement placement parameters from the advertiser. The advertisement placement parameters define the specifics regarding the manner in which the advertiser wishes to distribute the advertisement (e.g., how, where, when, and to whom the advertisement should be distributed). Exemplary advertisement placement and fee parameters include, but are not limited to, a placement method, a location, number of views or clicks on the ad, a distribution date, a campaign duration, one or more target professional profiles, one or more target icon communities, one or more target genres, one or more target professional network communities, and one or more target events. One having ordinary skill in the art will appreciate that other advertisement placement parameters may be used in accordance with embodiments of the present invention.

In an embodiment, the professional network icon system may be configured to allow users to comment on and/or rate an advertisement, advertiser, and/or concierge service. In addition, in an embodiment, the advertiser may limit cost or receive a cost estimate, pay a fee and receive data, purchase orders and statistics regarding the effectiveness of the ad within the selected icon system.

According to an embodiment of the present invention, users may earn points, icon badges, status or credits for using or redeeming offers or for selecting official branded icons from the icon profile creator, for taking surveys or voting within the system or in other ways, possibly in lieu of paying a monthly fee for the service. As described above, advertisements, news and/or promotions may be placed on screens relating to a selected icon or group or community.

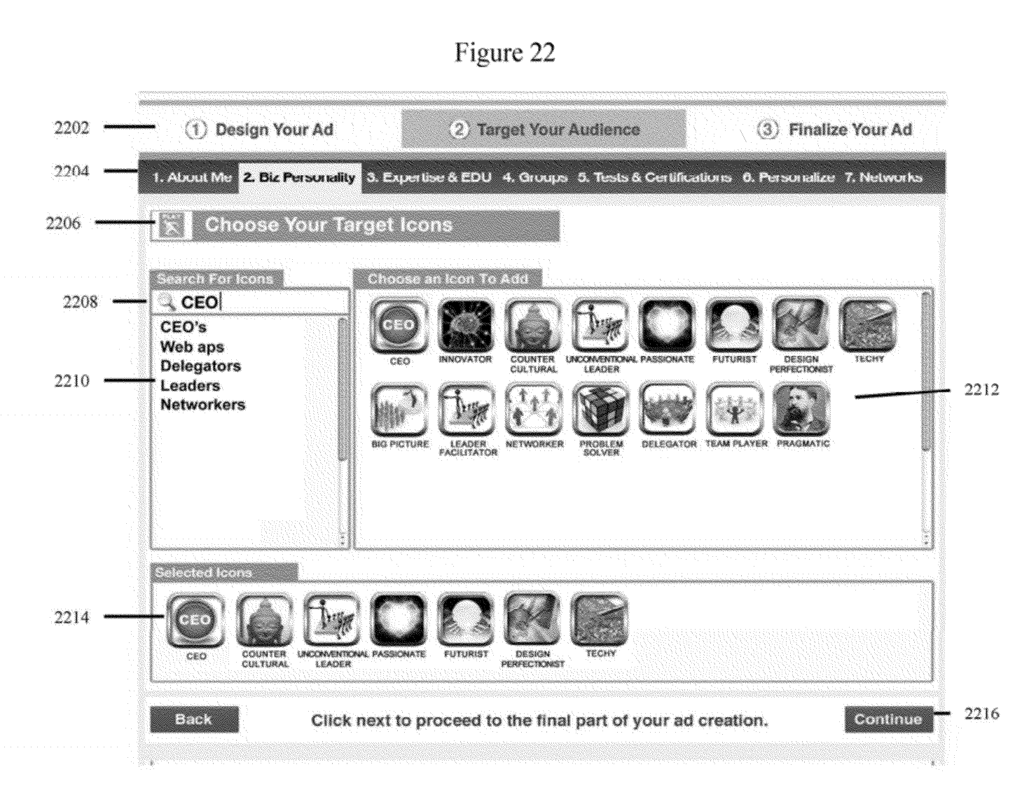

FIG. 22 illustrates an exemplary interface of the professional network icon system displaying an exemplary advertisement creation and delivery tool 2202, according to embodiments of the present invention. As shown in FIG. 22, an advertiser may select one or more of a zone, demographics and/or target icons 2204 for use in connection with the creation and distribution of an advertisement and/or an ad campaign. In the example shown in FIG. 22, the advertiser is presented with the “Choose Your Target Icons” functionality 2206 for use in selecting one or more icons for use in targeting users of the professional network icon system.

In an embodiment, the advertiser may select from and/or search for a number of icon categories 2208 associated with a genre. In this example, multiple professional genres 2210 are presented to the advertiser based on the advertiser's search for business-related icons. Upon a selection of a “CEO” genre or icon from the genre and/or icon listing 2210, a pallet of related icons 2212 is presented to the advertiser. From the pallet of related icons 2212, the advertiser may choose one or more icons to add to the targeting criteria for the advertisement and/or ad campaign. The one or more icons selected by the advertiser are displayed in a “Selected Icons” 2214 portion of the display. Following selection of the icon selection as part of the targeting criteria process, the advertiser may click a “Continue” button 2216 to proceed with the advertisement creation method.

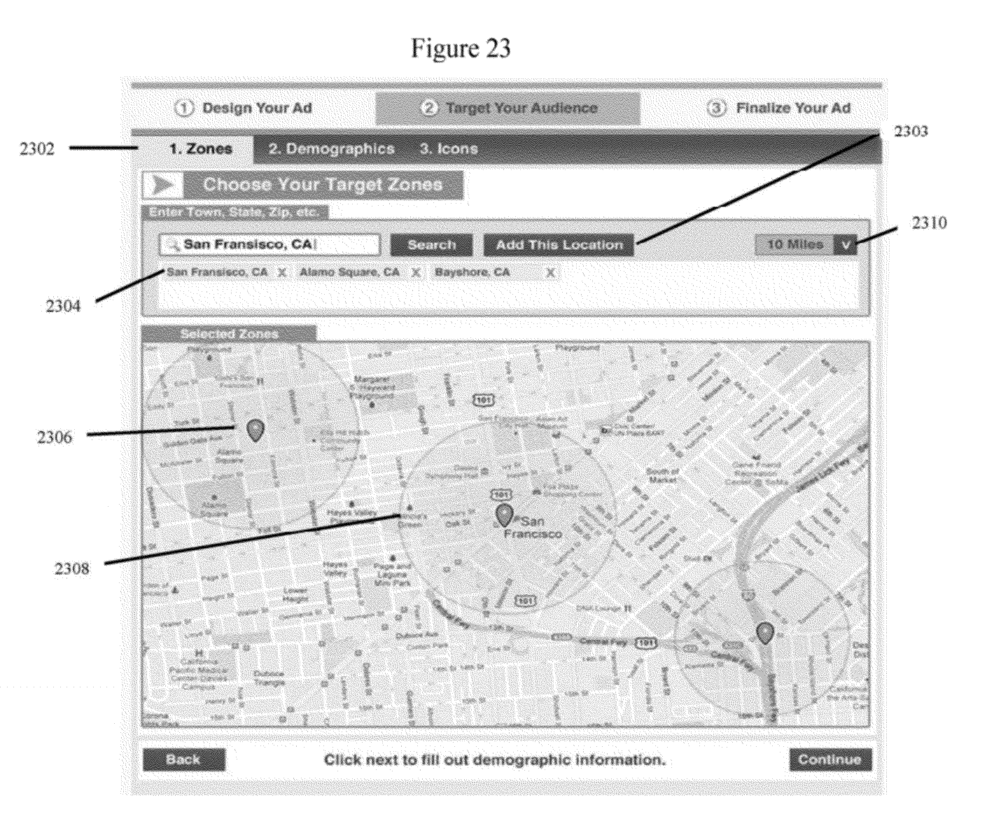

FIG. 23 illustrates an exemplary interface of the professional network icon system displaying an exemplary advertising delivery tool, according to embodiments of the present invention. As shown in FIG. 23, the advertiser may select one or more zones (or geographic areas) 2302 as part of the targeting criteria for the advertisement and/or ad campaign by interacting with an actionable button, such as the “Add This Location” button 2303. In an embodiment, the advertiser may enter or adjust multiple zones in a selected zone field 2304 and/or on a corresponding map. As shown, a specified location may be identified by an indicator 2306 and a corresponding zone or region surrounding the specified location (e.g., zone 2308). In an embodiment, the advertiser may specify the size of the zone or region surrounding the specified location using, for example, the zone indicator drop down menu 2310.

According to embodiments of the present invention, in an embodiment, users may proactively search for concierge services based on their icon interest, via a concierge search system. Users may also indicate or push their level of interest in offers for each listed interest, brand, things, travel, or favorite activity which may include food and retail locations. In an embodiment, concierges, advertisements, or offers may be rated, ranked by and shared with other users. For example, highly-rated services, advertisements and/or offers may receive higher priority and more placement opportunities in the icon system.

In an embodiment, advertisements, coupons, offers, news and other promotions may be administered by the icon system or by a social network. In an example, a user may highlight his or her diving hobby icon as an “active interest” and identify secondary icons and tags for their certifications and completed dives. The user may add a new zone in the user profile prior to or after travel from Denver to Santa Monica and indicate an open calendar day for this coming Sunday morning. The local concierges and advertisers may be notified of a match via the icon system, calendar function or a post may be sent to the open diving community feed under open invitations by the diver. In this example, a concierge service vendor may then provide an offer in the available time slot. In an embodiment, the additional notification feature may be part of a premium account which may increase the monthly access fee for the concierge.

In another example, a professional user may select a “diving” icon as one of his or her top local traveling interests, thereby increasing the likelihood that a business would send a special concierge offer related to diving. In an embodiment, a user rating may be provided to concierges regarding the quality or frequency of acceptance of a user for posting active interests. In this example, the registered diving concierges or related advertisers may receive a message derived by a concierge search feature from this user requesting diving offers, or, alternatively, the user may proactively search a concierge database and select the best personality or secondary match, best rated or lowest cost dive master. In an embodiment, selection of a service provider may be strongly based on having strong commonality in other areas and user ratings.

In an embodiment, when a user views their profile, a highlight or indicator may be used to indicate an offer for diving has arrived with a pop up window or display, a revealing display tile, an inserted blog advertisement, an email or a text message including the details of the offer a credit card may be linked to the user account in order to hold or purchase a service or product offer by pressing a “book it” or purchase icon.

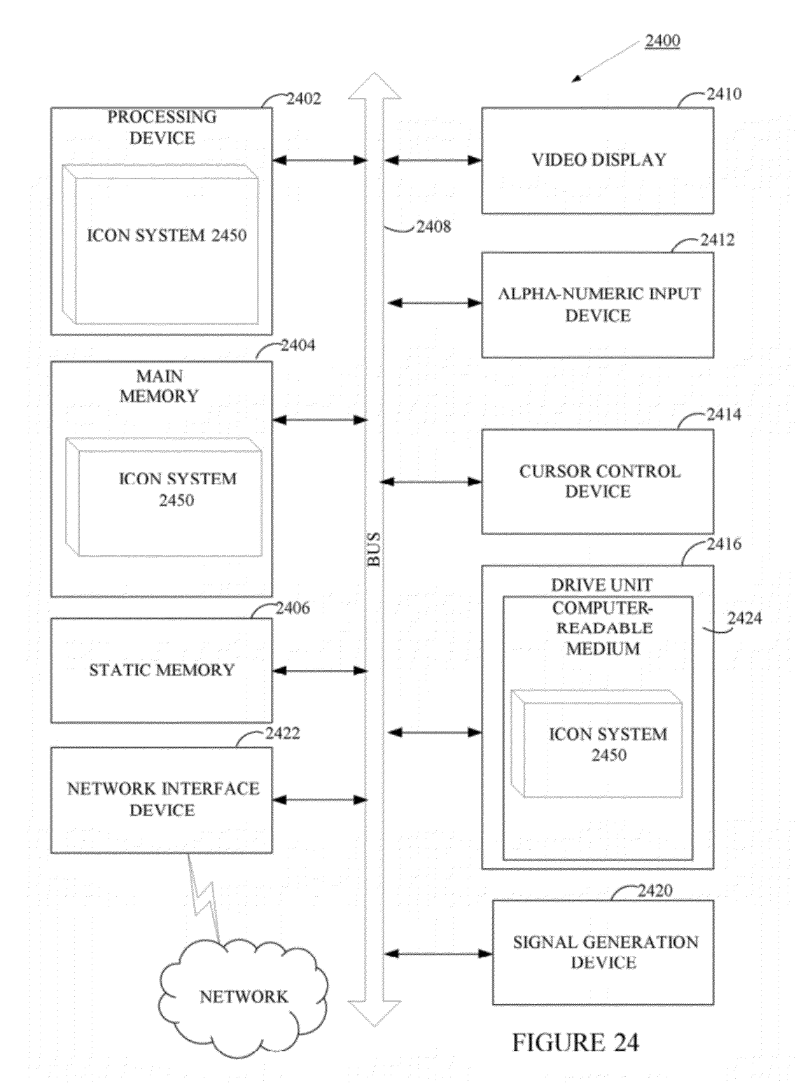

FIG. 24 illustrates a diagrammatic representation of a machine in the exemplary form of a computer system 2400 within which a set of instructions, for causing the machine to perform any one or more of the methodologies discussed herein, may be executed. In some embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 2400 includes a processing device (processor) 2402, a main memory 2404 (e.g., read-only memory (ROM), flash memory, dynamic random access memory (DRAM) such as synchronous DRAM (SDRAM)), a static memory 2406 (e.g., flash memory, static random access memory (SRAM)), and a data storage device 2416, which communicate with each other via a bus 2408.

Processing device 2402 represents one or more general-purpose processing devices such as a microprocessor, central processing unit, or the like. More particularly, the processing device 2402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 2402 may also be one or more special-purpose processing devices such as an application specific integrated circuit (ASIC), a field programmable gate array (FPGA), a digital signal processor (DSP), network processor, or the like. A professional network icon system 2450 may be provided which is configured to perform the steps, operations, instructions, and functions described in detail in the present application. The professional network icon system 2450 may comprise processing device 102 configured to perform the operations and steps discussed herein.

The computer system 2400 may further include a network interface device 2422. The computer system 2400 also may include a video display unit 2410 (e.g., a liquid crystal display (LCD) or a cathode ray tube (CRT)), an alphanumeric input device 2412 (e.g., a keyboard), a cursor control device 2414 (e.g., a mouse), and a signal generation device 2420 (e.g., a speaker).

A drive unit 2416 may include a computer-readable medium 2424 on which is stored one or more sets of instructions (e.g., instructions of a professional network icon system 2450) embodying any one or more of the methodologies or functions described herein.

In an embodiment, the professional network icon system 2450 may be a software component (i.e., a set of instructions executable by a processing device of the computer system 100, such as processing device 102) configured to perform the actions, functions, steps, processes, procedures, etc. described in detail in the present application.

The instructions of the professional network icon system 2450 may also reside, completely or at least partially, within the main memory 2404 and/or within the processing device 2402 during execution thereof by the computer system 2400, the main memory 2404 and the processing device 2402 also constituting computer-readable media. The instructions of the professional network icon system 2450 may further be transmitted or received over a network via the network interface device 2422.

While the computer-readable storage medium 2424 is shown in an exemplary embodiment to be a single medium, the term “computer-readable storage medium” should be taken to include a single non-transitory medium or multiple non-transitory media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “maintaining”, “receiving”, “generating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method for professional networking, comprising:
maintaining a plurality of icons, wherein each icon represents a professional profile element;
receiving a selection of a plurality of icons from a first user; and
generating a first professional profile for the first user based on the plurality of selected icons.

2. The method of claim 1, further comprising receiving, from the first user, secondary descriptor information associated with at least one professional profile element associated with at least one of the plurality of selected icons.

3. The method of claim 2, wherein the secondary descriptor information comprises at least one a skill level indicator, a passion level indicator, an experience level, a goal, a method of contact, an invitation method, an approval counter, a concierge preference, a privacy preference, an advertising preference, a search term, a tag, a media file, a status update preference, a zone preference, a preference relating to receipt of an update, and a brand preference.

4. The method of claim 2, further comprising storing the secondary descriptor information in association with the at least one professional profile element associated with the at least one of the plurality of selected icons.

5. The method of claim 2, further comprising:
receiving, from a second user, a selection of one of the plurality of selected icons of the first professional profile; and
providing the secondary descriptor information associated with at least one professional profile element of the first professional profile to the second user.

6. The method of claim 2, further comprising restricting access to the secondary descriptor information by the second user based on a preference of the first user.

7. The method of claim 5, further comprising receiving a connection communication, from the second user, associated with the at least one professional profile element of the first professional profile.

8. The method of claim 1, further comprising:
comparing the first professional profile and a second professional profile associated with a second user in a compatibility function.

9. The method of claim 1, further comprising:
generating a compatibility score based on a comparison of the first professional profile and a second professional profile associated with a second user.

10. The method of claim 1, further comprising aggregating a plurality of users into a professional community environment based on one of the plurality of selected icons from the first professional profile.

11. The method of claim 1, wherein at least one professional profile element of the first professional profile comprises a communication preference associated with the at least one professional profile element.

12. The method of claim 11, further comprising delivering an icon-specific communication from the second user to the first user in accordance with the communication preference.

13. The method of claim 12, wherein the icon-specific communication is associated with a calendar function.

14. The method of claim 1, further comprising displaying at least one of the selected icons and associated secondary information on a calendar associated with the first user.

15. The method of claim 14, further comprising:
displaying, in association with the calendar, a toolbar comprising one or more of the plurality of selected icons of the first professional profile;
receiving a selection of one of the plurality of selected icons of the first professional profile; and
displaying, on the calendar, an event associated with the selected one of the plurality of selected icons of the first professional profile.

16. The method of claim 1, further comprising receiving, from the first user, a selection of a professional network community type.

17. The method of claim 16, further comprising configuring the plurality of icons and associated category information based on the selected professional network community type.

18. The method of claim 1, further comprising connecting the first professional profile with one or more professional network environments.

19. The method of claim 18, further comprising:
comparing the first professional profile to a second professional profile associated with a second user;
generating a compatibility result associated with the first user and second user; and
displaying the compatibility result to the first user and the second user.

20. The method of claim 1, further comprising:
receiving search criteria from an advertiser; and
providing the advertiser with information associated with one or more of the plurality of selected icons of the first professional profile based on the search criteria.

21. The method of claim 20, further comprising delivering an advertisement from the advertiser to the first user.

22. The method of claim 1, further comprising receiving an advertising preference from the first user associated with one or more of the plurality of selected icons of the first professional profile.

23. The method of claim 1, further comprising:
comparing the first professional profile with a set of user profiles maintained in a searchable database;
generating a search result; and
displaying the search result in association with the first professional profile.

24. The method of claim 23, wherein the comparing is based on at least one icon of the first professional profile.

25. The method of claim 23, wherein the comparing is based on one or more common icons shared by the first professional profile and the set of user profiles.

26. The method of claim 23, wherein the comparing is based on secondary descriptor information associated with the first professional profile and the set of user profiles.

27. The method of claim 23, wherein the comparing is based on a zone associated with the first professional profile and the set of user profiles.

28. The method of claim 23, wherein the comparing is based on one or more compatibility preferences selected by the first user.

29. The method of claim 23, wherein the search result comprises one or more compatibility scores.

30. The method of claim 23, further comprising generating a compatibility smart clique score associated with the first professional profile and a second professional profile associated with a second user.

31. The method of claim 30, wherein the compatibility smart clique score is based on one or more search icons received from the first user and at least one additional common icon comprised in the first professional profile and the second professional profile.

32. The method of claim 23, further comprising generating a plurality of compatibility smart clique scores associated with the first professional profile and a set of other user profiles.

33. The method of claim 1, further comprising integrating the first professional profile into one or more external professional network environments via an API.

34. The method of claim 1, further comprising providing a blog associated with one or more of the plurality of selected icons.

35. The method of claim 1, further comprising:
receiving, from the first user, at least one of an image, a video, an icon animation or an icon description; and
generating a custom icon based on the at least one of an external image, a video, an icon animation or an icon description.

36. The method of claim 35, further comprising adding the custom icon to a library comprising the plurality of icons.

37. The method of claim 36, further comprising:
receiving, from a second user, a selection of search criteria comprising the custom icon; and
matching the first user and the second user based on the custom icon.

38. The method of claim 35, further comprising receiving, from the first user, secondary descriptor information associated with the custom icon.

39. The method of claim 1, further comprising associating one or more tags with the first professional profile.

40. The method of claim 1, further comprising associating the one or more tags with at least one of a search engine and a compatibility engine.

41. The method of claim 1, further comprising generating the first professional profile in a resume format.

42. A method comprising:
maintaining a plurality of icons, wherein each icon represents a professional profile element;
receiving a selection of a plurality of icons from a first user;
storing personalized information from the first user associated with one or more of the plurality of selected icons;
generating a first professional profile for the first user based on the plurality of selected icons; and
adding the first professional profile to a searchable database comprising a plurality of user profiles.

43. The method of claim 42, further comprising:
receiving, from the first user, search criteria;
conducting a search of the searchable database based on the search criteria; and
identifying one or more of the plurality of user profiles based on the search criteria.

44. The method of claim 43, further comprising reporting a compatibility result comparing the first professional profile and one or more of the identified plurality of user profiles.

45. The method of claim 44, further comprising receiving a connection request from the first user associated with one or more of the reporting a compatibility result comparing the first professional profile and one or more of the identified plurality of user profiles.

46. The method of claim 42, further comprising receiving a selection of a professional network environment type.

47. The method of claim 46, wherein the professional network environment type comprises at least one of a blog, a billboard, a video-based system, social gaming system, and an external API professional network.

48. A computing device comprising:
a memory; and
a processing device coupled to the memory, wherein the processing device is configured to:
maintain a plurality of icons, wherein each icon represents a professional profile element,
receive a selection of a plurality of icons from a first user, and
generate a first professional profile for the first user based on the plurality of selected icons.

49. A non-transitory computer-readable storage medium including instructions that, when executed by a processing system, cause the processing system to perform a method for professional networking, the method comprising:
maintaining a plurality of icons, wherein each icon represents a professional profile element;
receiving a selection of a plurality of icons from a first user; and
generating a first professional profile for the first user based on the plurality of selected icons.
